(19) United States
(12) Patent Application Publication
(10) Pub. No.: US 2020/0141832 A1
(43) Pub. Date: May 7, 2020

(54) ECCENTRICITY MEASURING METHOD, LENS MANUFACTURING METHOD, AND ECCENTRICITY MEASURING APPARATUS

(71) Applicant: CANON KABUSHIKI KAISHA, Tokyo (JP)

(72) Inventors: Atsushi Maeda, Fujisawa-shi (JP); Kenichi Miyazato, Utsunomiya-shi (JP)

(21) Appl. No.: 16/662,393

(22) Filed: Oct. 24, 2019

(30) Foreign Application Priority Data
Nov. 2, 2018 (JP) 2018-207797

(51) Int. Cl. G01M 11/02; G01M 11/00

(52) U.S. Cl. CPC G01M 11/0221; G01B 11/24; G01M 11/005

(57) ABSTRACT

An eccentricity measuring method includes a forming step of dividing reflected light from a first surface and a second surface of a test lens by a plurality of optical elements and of forming a first spot group and a second spot group, and an eccentricity calculating step of calculating an eccentricity amount of the first surface relative to the second surface based on the first spot group and the second spot group.

### BACKGROUND OF THE INVENTION

### Field of the Invention

The present invention relates to an eccentricity measuring method, a lens manufacturing method, and an eccentricity measuring apparatus.

### Description of the Related Art

An aspheric lens has recently been used for an optical apparatus, such as a camera and a semiconductor exposure apparatus, in order to reduce the size of its optical system. In addition, highly accurately manufacturing the aspheric lens is required for the high definition of an image obtained by the optical apparatus. Thus, a technique is demanded which measures the relative eccentricity (inter-surface eccentricity) of both surfaces of the aspheric lens with high accuracy.

Japanese Patent No. (“JP”) 4767255 discloses a method for obtaining an inter-surface eccentricity by holding an aspheric lens with a holder having a through-hole. This method initially scans a first surface of the aspheric lens and the through-hole and finds a positional relationship between them. Next, this method inverts the aspheric lens together with the holder, scans a second surface of the aspheric lens and the through-hole, and finds a positional relationship between them. Thereafter, the positional relationship between the first surface and the second surface or the inter-surface eccentricity (or decentering) is obtained with reference to the position of the through-hole.

However, the method of JP 4767255 needs to scan both surfaces of the aspheric lens by inverting the aspheric lens, and thus requires a long time to measure the inter-surface eccentricity.

### SUMMARY OF THE INVENTION

The present invention provides an eccentricity measuring method, a lens manufacturing method, and an eccentricity measuring apparatus, each of which can measure inter-surface eccentricity of a test lens at high speed and with high accuracy.

An eccentricity measuring method according to one aspect of the present invention includes a forming step of dividing reflected light from a first surface and a second surface of a test lens by a plurality of optical elements and of forming a first spot group and a second spot group, and an eccentricity calculating step of calculating an eccentricity amount of the first surface relative to the second surface based on the first spot group and the second spot group. A lens manufacturing method according to another aspect of the present invention includes a producing step for producing a test lens, and an eccentricity measuring step for measuring an eccentricity amount of the test lens using the eccentricity measuring method.

An eccentricity measuring apparatus according to another aspect of the present invention includes a plurality of optical elements configured to divide reflected light from a first surface and a second surface of a test lens and to form a first spot group and a second spot group; and a calculator configured to calculate an eccentricity amount of the first surface relative to the second surface based on the first spot group and the second spot group.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a test lens.

FIG. 2 is a schematic diagram illustrating a configuration of an eccentricity measuring apparatus.

FIG. 3 is a schematic diagram illustrating a configuration of a detector.

FIG. 4 is a schematic diagram illustrating a configuration of a microlens array.

FIG. 5 is a schematic diagram of a spot image to be captured.

FIG. 6 is a flowchart showing a procedure for measuring an inter-surface eccentricity of a test lens according to a first embodiment.

FIG. 7 is a flowchart showing calculation processing of a spot parameter group according to the first embodiment.

FIG. 8 is a schematic diagram for explaining how light reflected on a first surface near a measurement optical axis enters a detector and forms a spot.

FIG. 9 is a flowchart illustrating calculation processing of a provisional back surface inclination according to the first embodiment.

FIG. 10 illustrates a simulation result of a phase of a photoelectric field for a light beam having two wavefronts.

FIGS. 11A and 11B illustrate a simulation result regarding a shift amount calculation error of a spot group (spots).

FIG. 12 is a flowchart illustrating a procedure for measuring the eccentricity of the lens of the test lens according to a third embodiment.

FIG. 13 is a flowchart illustrating a detailed calculation procedure of a provisional back surface inclination according to a seventh embodiment.

FIG. 14 is a schematic diagram of a configuration of the test lens according to an eighth embodiment.

FIG. 15 is a flowchart illustrating an eccentricity measuring procedure according to a tenth embodiment.

FIG. 16 is a flowchart illustrating a procedure for acquiring a first temporary spot image according to the tenth embodiment.

FIG. 17 is a flowchart illustrating a procedure of the step S405 according to the tenth embodiment.

FIGS. 18A and 18B illustrate a simulation result of noises included in the first differential spot image according to the tenth embodiment.

FIG. 19 is a flowchart illustrating a procedure of the step S405 according to a twelfth embodiment.

### DESCRIPTION OF THE EMBODIMENTS

Referring now to the accompanying drawings, a description will be given of embodiments according to the present invention. Corresponding elements in respective figures will be designated by the same reference numerals, and a duplicate description thereof will be omitted.

### First Embodiment

### Explanation of Test Lens and Inter-Surface Eccentricity

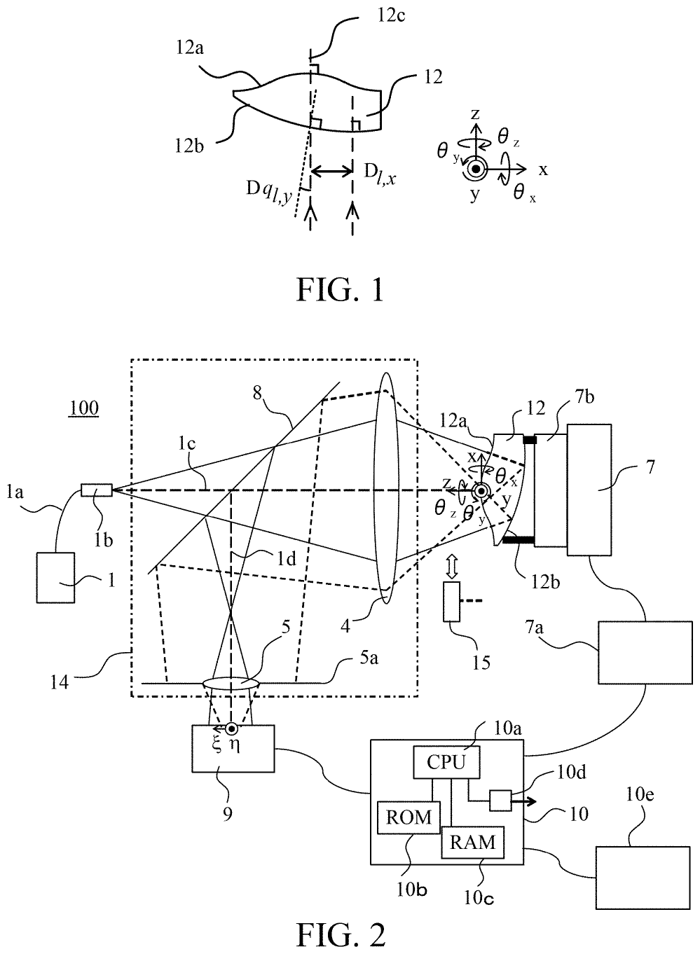

FIG. 1 is a schematic diagram for explaining a configuration of a test lens 12 that is a target to be measured. The test lens 12 has a first surface 12a and a second surface 12b. The first surface 12a is an aspheric surface (axisymmetric aspheric surface) showing an axisymmetric shape relative to an aspheric axis 12c. In other words, the test lens 12 is an aspheric lens. The second surface 12b is a spherical surface in this embodiment, but may be an aspherical surface. The test lens 12 is a biconvex lens in this embodiment, but may be a biconcave lens or a meniscus lens. The test lens 12 may be formed by grinding and polishing or by molding.

When the xyz orthogonal coordinate system is defined as illustrated in FIG. 1, the inter-surface eccentricity of the test lens 12 measured in this embodiment is an optical axis shift amount Δ_{l, x} in the x direction and an optical axis shift amount Δ_{l, y} in the y direction of the optical axis of the second surface 12b relative to the aspherical axis 12c of the first surface 12a. Herein, the optical axis of the second surface 12b is a line parallel to the aspherical axis 12c and perpendicularly intersects the second surface 12b. As long as a one-to-one correspondence with the optical axis shift amounts Δ_{l, x} and Δ_{l, y}, such as the inclination Δθ_{l, x} in the θₓ direction and the inclination Δθ_{l, y} in the θ_{y} direction of the second surface 12b relative to the aspherical axis 12c, they may be measured as inter-surface eccentricity. The inclinations Δθ_{l, x} and Δθ_{l, y} will be referred to as back surface inclinations in this embodiment. In FIG. 1, since the second surface 12b inclines to the −θ_{y} direction, the back surface inclination Δθ_{l, y} in the figure takes a negative value.

### Explanation of Eccentricity Measuring Apparatus

FIG. 2 is a schematic diagram for explaining the configuration of the eccentricity measuring apparatus 100. The eccentricity measuring apparatus 100 includes a light source 1, a single mode optical fiber 1a, an optical fiber connector 1b, lenses 4 and 5, a stage 7, a stage controller 7a, a holder 7b, a half-mirror 8, a detector 9, a processor 10, a display unit 10e, and a length measuring unit 15.

Light from the light source 1 is emitted from the optical fiber connector 1b via the single mode optical fiber 1a, and travels as a spherical wave along a measurement optical axis 1c. The light source 1 uses a monochromatic laser in this embodiment, but may use a light emitting diode or the like.

The stage 7 moves the test lens 12 based on a command from the stage controller 7a. In the stage 7, similar to the test lens 12, the xyz orthogonal coordinate system illustrated in FIG. 2 is defined. The z axis is parallel to the measurement optical axis 1c, and x=y=0 is established on the measurement optical axis 1c. Based on this coordinate system, the stage 7 is movable in six axial directions of x, y, z, θₓ, θ_{y}, and θ_{z}. The holder 7b is attached to the stage 7 and holds the test lens 12.

The lens 4 converts the light from the optical fiber connector 1a that has transmitted through the half-mirror 8, into convergent light, and illuminates the first surface 12a of the test lens 12. The half-mirror 8 is disposed at a slope of 45° relative to the measurement optical axis 1c. Thereby, a traveling direction of the reflected light of the test lens 12 is converted from a direction parallel to the measurement optical axis 1c to a direction parallel to a measurement optical axis 1d orthogonal to the measurement optical axis 1c. The measurement optical axes 1c and 1d intersect each other on the half-mirror 8. The lens 5, together with the half-mirror 8 and the lens 4, constitutes an optical system that focuses the light has just been reflected by the first surface 12a, on the detector 9 with an imaging magnification m. In other words, the lens 5, the half-mirror 8, and the lens 4 serve as a imaging lens 14, and the first surface 12a and the detector 9 are conjugate with each other via the imaging lens 14.

The focal length and effective diameter of each of the lenses 4 and 5 are determined by the effective diameter and curvature radius of the first surface 12a and the size of the detection surface of the detector 9. The distance between the lens 4 and the test lens 12 is set so that the light that has transmitted through the lens 4 converges near the center of curvature of the first surface 12a. Thereby, the light that has transmitted through the lens 4 enters the first surface 12a almost perpendicularly over its entire surface, and the reflected light travels through the same optical path as the incident light up to the half-mirror 8. The imaging lens 14 may include a movable mechanism or an exchange mechanism so that the above condition is always satisfied for the test lens 12 having a different design shape. However, an angle of the reflected light of the first surface 12a depends on the aspheric amount (deviation from the spherical surface) and the shape error of the first surface 12a. When the aspherical amount of the first surface 12a is large, the angle of the reflected light on the first surface 12a shifts from the angle of the incident light.

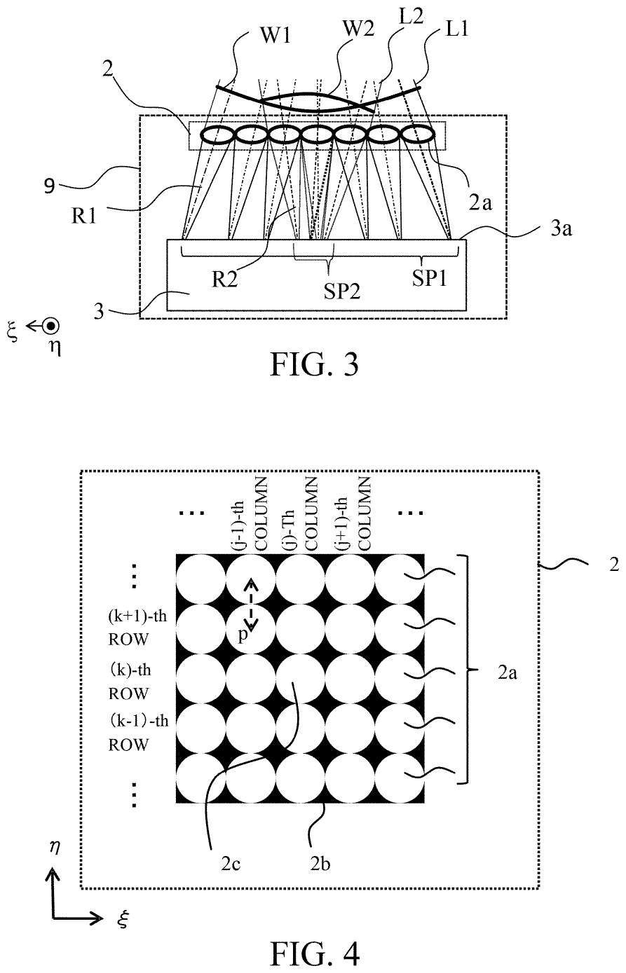

FIG. 3 is a schematic diagram illustrating a configuration of the detector 9. The detector 9 includes a microlens array (MLA) 2 including a plurality of microlenses (ML) 2a that are a plurality of optical elements, and an image sensor 3. The image sensor 3 may use a CCD camera or a CMOS camera. Instead of the MLA 2, a mirror array in which a plurality of minute concave mirrors are arranged may be introduced. In the detector 9, as illustrated in FIG. 3, a ξη orthogonal coordinate system is defined. Both the ξ axis and the η axis are orthogonal to the measurement optical axis 1d, and ξ=η=0 on the measurement optical axis 1d. A light receiving surface 3a of the image sensor 3 and the MLA 2 are arranged parallel to the ξη plane, and both are separated by a surface interval 1. The detector 9 has the same configuration as a Shack-Hartmann sensor (SHS) commonly used as a light wavefront sensor, and may use a commercially available SHS.

In this embodiment, MLA 2 is made to coincide with the conjugate surface of the first surface 12a. However, other surfaces in the detector 9, such as the light receiving surface 3a, may coincide with the conjugate surface of the first surface 12a.

FIG. 4 is a schematic diagram for explaining the configuration of the MLA 2. The MLA 2 includes circular MLs 2a arranged at regular intervals on the same plane, and a light shielding mask 2b for shielding light incident on a portion other than the ML 2a. Each ML 2a has a focal length of f, and is approximately equal to the surface interval 1 between the light receiving surface 3a and MLA 2. The non-light-shielding area of the light-shielding mask 2b is circular, and its center substantially coincides with the optical axis of the ML 2a. However, the shape of the ML 2a and the light shielding mask 2b is not limited to a circle but may be a square or a hexagon. In this embodiment, as illustrated in FIG. 4, MLs 2a are arranged in a square lattice pattern at intervals p along the ξ direction and η direction. For example, ML 2c, which is one of ML 2a, is expressed as “ML on the k-th row and j-th column.” However, MLs 2a are not necessarily arranged in a square lattice pattern. In this embodiment, for description convenience, the ML closest to the measurement optical axis 1d will be referred to as “ML on the row 0-th row and 0-th column.”

The position of the optical axis of ML 2a (ξ_{0,j,k}, η_{0,j,k}) is previously acquired, for example, by a method disclosed in Applied Optics Vol. 44, no. 30, p 6419. The detector 9 is assembled so that the distance 1 is equal to the focal length f, but the assembly has a finite error. The distance 1 is also calibrated to acquire an accurate value in advance. In this embodiment, the distance between all the MLs 2a and the light receiving surface 3a is treated as being uniform with the surface interval 1, but the distances 1_{j, k} relative to the light receiving surface 3a are obtained for each ML 2a and reflected in a calculation expression for the back surface inclination described later.

The processor 10 includes a CPU 10a having a calculation function and serves as a calculator. The processor 10 can input an output signal of the image sensor 3 via an unillustrated interface, and output position control information of the test lens 12 to the stage controller 7a. Using these functions, the processor 10 performs measurement processing in accordance with the measurement procedure of the inter-surface eccentricity of the lens 12 to be described later. The measurement processing needs a program for the measurement processing, information on the configuration of the detector 9, information on the shapes and arrangement of the lenses 4 and 5, the half-mirror 8 and the test lens 12. These data are stored in a predetermined area of a memory such as a ROM 10b and a RAM 10c provided in the processor 10, for example.

The processor 10 includes a communicator 10d includes a communicator 10d, such as a network interface of IEEE802.3 standard, and is connected to a display unit 10e. The CPU 10a displays, for example, the measurement result of the inter-surface eccentricity of the test lens 12 or the evaluation result of the test lens 12 based on the measurement result on the display unit 10e, or transmits via the communicator 10d to another equipment in a lens manufacturing plant in which the eccentricity measuring apparatus 100 is installed.

### Description of Spot Image

When the test lens 12 is installed in the holder 7b, part of the light converged by the lens 4 is reflected by the first surface 12a. The wavefront of the light that has just been reflected, reflects the aspherical shape of the first surface 12a. The light reflected by the first surface 12a (first light) passes through the lens 4, is reflected by the half-mirror 8, is approximately collimated by the lens 5, and enters the detector 9. Part of the light converged by the lens 4 passes through the first surface 12a and is reflected by the second surface 12b. The light reflected by the second surface 12b (second light) once converges near the first surface 12a and then becomes divergent light, is approximately collimated by the lens 4, and enters the lens 5. However, since the second light entering the lens 5 has a light beam diameter that greatly exceeds the aperture diameter of the lens 5, most of the second light is blocked by the holder 5a that holds the lens 5. Only the second light near the measurement optical axis 1d that is not blocked by the holder 5a is converged by the lens 5 and enters the central portion of the detector 9.

FIG. 3 illustrates the first light L1 and the second light L2 entering the detector 9. FIG. 3 is a schematic diagram, and the number of MLs and spots is not limited to the illustrated number. Since the detector 9 is conjugate with the first surface 12a with respect to the imaging lens 14, the aspherical shape of the first surface 12a is reflected in the wavefront W1 of the first light L1 entering the detector 9. Thereafter, the first light L1 is divided by MLA 2 to form a spot group (spots) SP1 on the light receiving surface 3a of the image sensor 3. More specifically, the spot group SP1 is formed at the intersection between the normal line (light ray R1) of the wavefront W1 passing through the center of each ML and the light receiving surface 3a. The second light L2 is divided by MLA 2, and forms a spot group (spots) SP2 on the light receiving surface 3a. More specifically, the spot group SP2 is formed at the intersection between the normal line (light ray R2) of the wavefront W2 of the second light L2 passing through the center of each ML and the light receiving surface 3a.

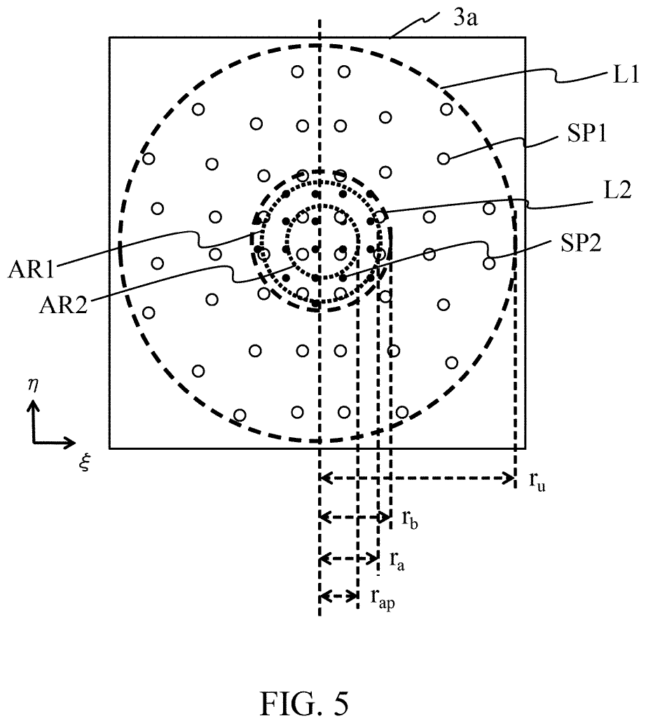

FIG. 5 is a schematic diagram of a spot image captured by the image sensor 3, and the number of spots is not limited to the illustrated number. The spot groups SP1 and SP2 are indicated by white and black dots, respectively. Since the first surface 12a is an aspherical surface, the wavefront W1 reflecting the shape is an aspherical wave. Therefore, although the MLs 2a are arranged at regular intervals in MLA 2, the spot group SP1 is arranged at irregular intervals. Since the first surface 12a is approximated by a spherical surface near the aspherical axis 12c, the wavefront W1 also becomes a spherical wave near the measurement optical axis 1d, and the spot group SP1 is arranged at regular intervals only near the measurement optical axis 1d (the central portion of the light receiving surface 3a). The second light L2 entering the detector 9 is convergent light, and the spot group SP2 formed thereby is more densely spaced than the spot group SP1 formed by collimated light. Since the second surface 12b is a spherical surface, the second light L2 is a spherical wave, and the spot group SP2 is arranged at regular intervals. In other words, both the spot groups SP1 and SP2 are arranged at substantially regular intervals near the measurement optical axis 1d.

Assume that (ξ_{u, j, k}, η_{u, j, k}) is a position of the spot formed by the first light L1 passing through “ML on the k-th row and j-th column,” and (ξ_{b, j, k}, η_{b, j, k}) is a position of the spot formed by the second light L2 passing through it. When the “ML on the k-th row and the j-th column” is near the measurement optical axis 1d, these spot positions are approximated by the following expressions (1) to (4).

ξ_{u,j,k}=ξ_{u,0,0}+jqᵤ (1)

η_{u,j,k}=η_{u,0,0}+kqᵤ (2)

ξ_{b,j,k}=ξ_{b,0,0}+jq_{b} (3)

η_{b,j,k}=η_{b,0,0}+kq_{b} (4)

qᵤ is the spot interval of the spot group SP1, and q_{b} is the spot interval of the spot group SP2. (ξ_{u, 0, 0}, η_{u, 0, 0}) is the position of the spot formed by the first light L1 that has transmitted through “ML on 0-th row and 0-th column,” and the shift amount of the spot group SP1 (first shift amount). (ξ_{b, 0, 0}, η_{b, 0, 0}) is the position of the spot formed by the second light L2 that has passed through “ML on the 0-th row and 0-th column,” and represents the shift amount (second shift amount) of the spot group SP2.

### Explanation of Inter-Surface Eccentricity Measuring Procedure: Parameter Calculation

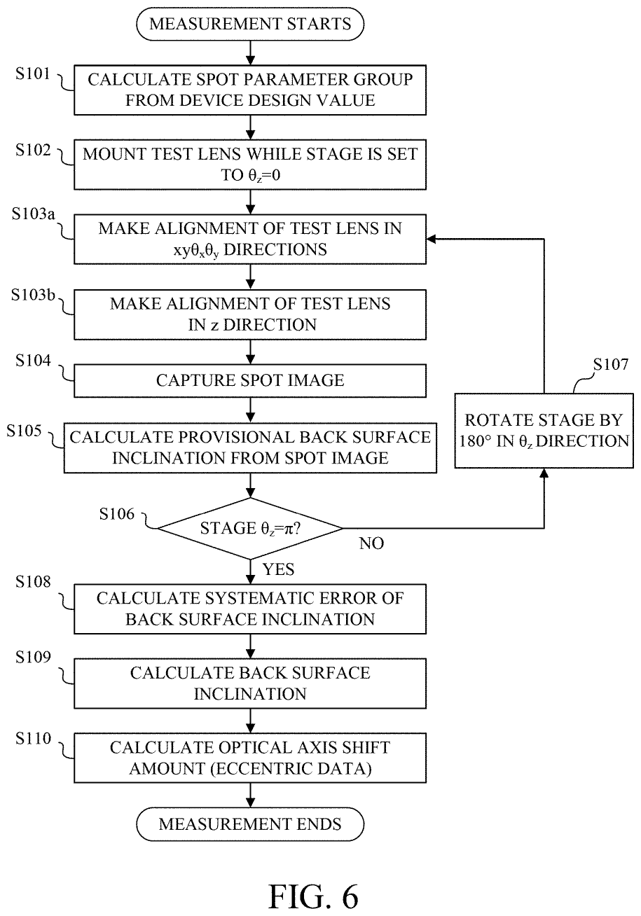

FIG. 6 is a flowchart showing a procedure for measuring the inter-surface eccentricity of the test lens 12 according to this embodiment. The inter-surface eccentricity of the test lens 12 is measured after a working step of manufacturing a lens by processing a workpiece in manufacturing the lens.

In the step S101, the processor 10 calculates a relevant parameter group (spot parameter group) from a device set value for a spot that may be imaged by the image sensor 3.

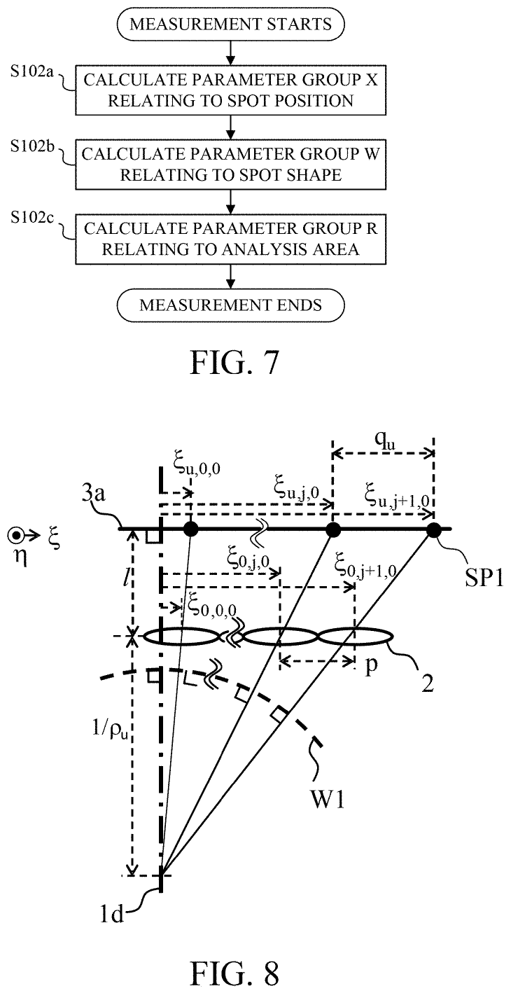

FIG. 7 is a flowchart showing calculation processing of the spot parameter group in the step S101. In the step S101a, the processor 10 calculates a parameter group X (=(ξ_{u, 0, 0}, η_{u, 0, 0}, ξ_{b, 0, 0}, η_{b, 0, 0}, qᵤ, q_{b})). Each of the parameters constituting the parameter group X is used to express the spot position in the expressions (1) to (4). Each parameter in the parameter group X is calculated by the following expressions (5) to (10).

$$\begin{matrix}{q}_{u} = ( 1 + {ρ}_{u} l ) p & ( 5 ) \\ {q}_{b} = ( 1 + {ρ}_{b} l ) p & ( 6 ) \\ {ξ}_{u , 0 , 0} = \frac{{q}_{u}}{p} {ξ}_{0 , 0 , 0} & ( 7 ) \\ {η}_{u , 0 , 0} = \frac{{q}_{u}}{p} {η}_{0 , 0 , 0} & ( 8 ) \\ {ξ}_{b , 0 , 0} = \frac{{q}_{b}}{p} {ξ}_{0 , 0 , 0} & ( 9 ) \\ {η}_{b , 0 , 0} = \frac{{q}_{b}}{p} {η}_{0 , 0 , 0} & ( 10 )\end{matrix}$$

Herein, ρᵤ and ρ_{b} represent the curvatures of the wavefronts W1 and W2 incident on the detector 9, respectively. For p, l, ξ_{0, 0, 0}, and η_{0, 0, 0}, previously acquired values may be substituted. ρᵤ and ρ_{b} may be analytically calculated from the designed value of the curvature of the light wavefront incident on the test lens 12, the designed value of the imaging magnification of an imaging lens 14, and the designed shape and refractive index of the test lens 12. Alternatively, the ray tracing may be performed based on these parameters.

FIG. 8 is a schematic diagram for explaining how the first light L1 near the measurement optical axis 1d is incident on the detector 9 to form a spot. Although not shown, the state in which the second light L2 enters the detector 9 to form a spot is the same as that of the first light L1. The expressions (5) to (10) are geometrically derived from FIG. 8. In FIG. 8, the optical axis of the second light L2 coincides with the measurement optical axis 1d. This is based on the premise that all optical surfaces constituting the eccentricity measuring apparatus 100 are axisymmetric to the measurement optical axes 1c and 1d in FIG. 8 and the expressions (7) to (10). More specifically, it is premised that the aspherical axis 12c coincides with the measurement optical axis 1c, the test lens 12 has no back surface inclination, and the lenses 4 and 5 have shapes axisymmetric about the measurement optical axes 1c and 1d, respectively.

In the step S101b, the processor 10 calculates a parameter group W (=(wᵤ, w_{b}, Iᵤ, I_{b})). wᵤ and w_{b} represent the spot radii constituting the spot groups SP1 and SP2, respectively. Iᵤ and I_{b} represent the peak intensities of the spot groups SP1 and SP2, respectively. Both parameters relate to the spot shape. The spot radii wᵤ and w_{b} are calculated using a light propagation expression such as the Fresnel diffraction or Fraunhofer diffraction from the designed value of ML 2a and the surface interval 1 between MLA 2 and the light receiving surface 3a. Instead of using the light propagation formula, the light propagation may be calculated by the angular spectrum method, the FDTD method, or the like, and the shape of the wavefront W1 of the first light L1 or the wavefront W2 of the second light L2 may be considered in the calculation. The peak intensities Iᵤ and I_{b} are calculated from the irradiation densities of the first light L1 and the second light L2 entering the detector 9, the spot radii wᵤ and w_{b}, and the light receiving sensitivity of the image sensor 3. The irradiation densities of the first light L1 and the second light L2 may be calculated analytically based on the output of the light source 1, the imaging magnification of the imaging lens 14, or the like, or may be simulated by ray tracing.

In the step S101c, the processor 10 calculates a parameter group R (=rᵤ, r_{b}, rₐₚ, rₐ)). As illustrated in FIG. 5, each of rᵤ and r_{b} represents the light beam radius of the first light L1 and the light beam radius of the second light L2 entering the light receiving surface 3a. rₐₚ and rₐ represent the radii (analysis radii) of areas analyzed for the spot image in the pre-fitting step and the fitting step described later, respectively. Each of the parameters relates to the spot image analysis area. The beam radii rᵤ and r_{b} may be analytically calculated based on the outer diameter of the test lens 12, the imaging magnification of the imaging lens 14, or the like, or may be simulated by ray tracing. The analysis radius rₐₚ may be set to about a few times the spot interval qᵤ. Thereby, the pre-fitting processing can be accelerated with necessary minimum accuracy. The analysis radius rₐ may be set to a value smaller than the light beam radius r_{b} of the second surface 12b by about the spot interval q_{b}. This configuration can fit many spot groups SP2 while excluding spots with a light amount reduced due to light shielding of the edge of the lens 5, and can realize highly accurate fitting.

The processing in the step S101 thus ends. The parameter groups X, W, and R calculated in the step S101 are stored in the ROM 10b (or RAM 10c).

The processing in the step S101 may be performed in advance to the measurement of the inter-surface eccentricity. The parameter group is calculated based on the device design value in this embodiment, but may be actually measured on the eccentricity measuring apparatus 100.

### Measurement Procedure of Inter-Surface Eccentricity: Acquisition of Provisional Back Surface Inclination

In the step S102, the test lens 12 is placed on the holder 7b. At that time, the aspherical axis 12c is made approximately to coincide with the measurement optical axis 1c. Hence, a mark may be previously provided on the holder 7b, and the test lens 12 may be installed in accordance with the mark, the holder 7b may include an unillustrated positioning pin which the test lens 12 contacts. The position of the stage 7 in the θ_{z} direction is set to 0°. As a result of installing the test lens 12 on the holder 7b, the spot groups SP1 and SP2 are formed on the light receiving surface 3a as illustrated in FIG. 5. The processing of the step S102 corresponds to a forming step.

In the step S103a, the alignment of the test lens 12 is made in the x direction, the y direction, the θₓ direction, and the θ_{y} direction.

In the step S103b, the alignment of the test lens 12 is made in the z direction.

In the step S104, the processor 10 causes the image sensor 3 to capture a spot image based on the spot groups SP1 and SP2, and acquires as a spot image the light intensity distribution I(ξ, η) on the light receiving surface 3a from the image sensor 3. The processing in the step S104 corresponds to the imaging step.

The processing after the step S105 below corresponds to the eccentricity calculation step.

In the step S105, the processor 10 calculates a provisional back surface inclination (Δθ_{l, x}, Δθ_{l, y}) from the spot image acquired in the step S104.

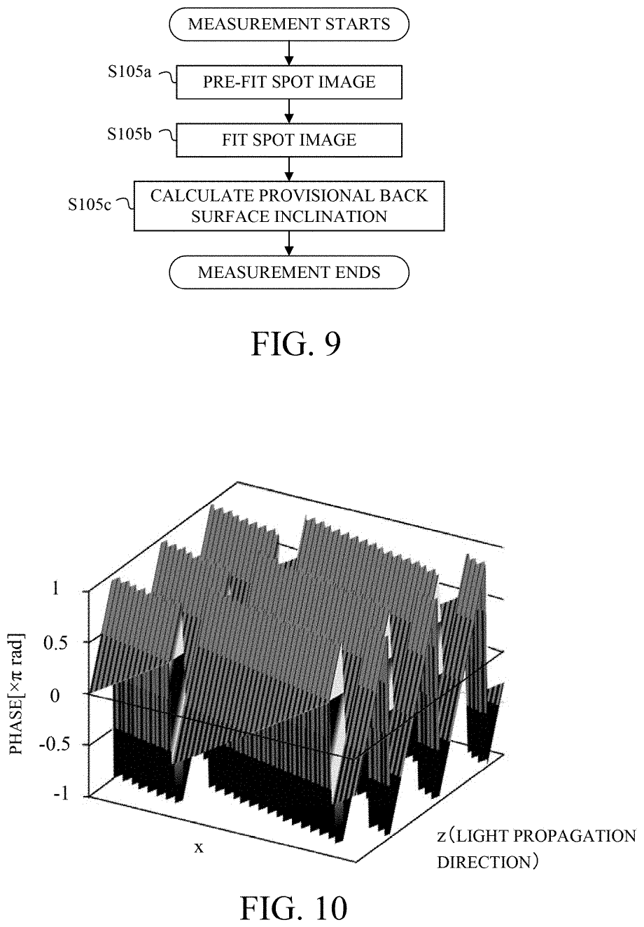

FIG. 9 is a flowchart showing the calculation processing of the provisional back surface inclination in the step S105. The step S105 includes the step S105a for pre-fitting a spot image, the step S105b for fitting the spot image, and the step S105c for calculating the provisional back surface inclination.

Among the three steps constituting the step S105, the second step S105b for fitting the spot image will be described first. This fitting calculates a parameter group X representing the spot position that minimizes the difference between the acquired spot image and the spot image calculated by the following expression (11).

$$I ( ξ , η ) = {\sum }_{j , k} {I}_{u} exp [ - \frac{{( ξ - {ξ}_{u , 0 , 0} - {jq}_{u} )}^{2} + {( η - {η}_{u , 0 , 0} - {kq}_{u} )}^{2}}{{w}_{u}^{2}} ] + {\sum }_{j , k} {I}_{b} exp [ - \frac{{( ξ - {ξ}_{b , 0 , 0} - {jq}_{b} )}^{2} + {( η - {η}_{b , 0 , 0} - {kq}_{b} )}^{2}}{{w}_{b}^{2}} ] \qquad ( 11 )$$

The calculation may use a nonlinear optimization program such as a solver function of Excel software or an fminsearch function of Matlab software. The spot image to be fitted is limited to the analysis area AR1 having the radius rₐ calculated in the step S101c.

A description will be given of the expression (11) used for the spot image modeling in the fitting. In the expression (11), the intensity distribution of each spot is expressed by a Gaussian function, and the spot image is expressed as a superposition thereof. As long as the intensity distribution of the spot is appropriately expressed, it is not limited to the Gaussian function, and a Bessel function, a sinc function, or the like may be used. It is assumed that the spots are arranged at regular intervals in both the spot groups SP1 and SP2 and follow the expressions (1) to (4). This premise is based on the fact that the analysis area AR1 is limited to the central portion of the light receiving surface 3a. As a result, the first term on the right side representing the spot group SP1 is a two-dimensional periodic function having a period qᵤ and a phase (2πξ_{u, 0, 0}/qᵤ, 2πη_{u, 0, 0}/qᵤ). The second term representing the spot group SP2 is a two-dimensional periodic function having a period q_{b} and a phase (2πξ_{b, 0, 0}/q_{b}, 2πη_{b, 0, 0}/q_{b}). In other words, the entire right side is the sum of periodic functions. The shift amount of the spot group is proportional to the phase of the periodic function and corresponds one-to-one.

A description will now be given of a relationship between the back surface inclination of the test lens 12 and the expression (11). As described above, the back surface inclination is defined as the difference between the inclination of the first surface 12a and the inclination of the second surface 12b. As the first surface 12a inclines, the wavefront W1 of the first light L1 is inclined and the spot group SP1 is shifted. As the second surface 12b inclines, the wavefront W2 of the second light L2 is inclined and the spot group SP2 is shifted. As a result, the back surface inclination is reflected on a shift between the shift amount (ξ_{u, 0, 0}, η_{u, 0, 0}) of the spot group SP1 and the shift amount (ξ_{b, 0, 0}, η_{b, 0, 0}) of the spot group SP2 or the phase shift between the first term on the right side and the second term on the right side in the expression (11). The parameter group X includes a parameter representing these shift amounts (phases), which is equivalent to information on the back surface inclination. This embodiment addresses this point, and this is the reason why the parameter group X is calculated in the step S105b.

In order to correctly fit the spot image using the expression (11) in the step S105b, it is necessary to input the highly accurate parameter group W. The step S101b calculates the parameter group W, which is calculated from the device design value, and does not reflect the manufacturing error of the eccentricity measuring apparatus 100. Hence, the parameter group W calculated in the step S101b is insufficient in accuracy to be used in the step S105b.

In fitting a spot image in a wide area with a nonlinear optimization program, high accuracy is required for initial values of the spot intervals qᵤ and q_{b} constituting the parameter group X. If the initial values of the spot intervals qᵤ and q_{b}, are deviated from the actual spot interval, the fitting is started from a state in which the positions of the spots on the outer periphery are largely deviated, and the convergence lowers. In the step S101a, the spot intervals qᵤ and q_{b} are calculated, but these are calculated from the device design values, and the manufacturing error of the eccentricity measuring apparatus 100 is not reflected. Hence, the accuracies of the spot intervals qᵤ and q_{b} calculated in the step S101a are insufficient to be used in the step S105b.

Accordingly, this embodiment performs the processing of the step S105a for pre-fitting the spot image before the processing of the step S105b. In the step S105a, pre-fitting is performed for the spot image in the analysis area AR2 smaller than the analysis area AR1 using the expression (11), and the parameter groups X and W are calculated. The values calculated in the step S101 are used as initial values of the parameter groups X and W in the pre-fitting. Since the pre-fitting analysis area AR2 is sufficiently small, a high convergence can be obtained even if the parameter groups X and W based on the device design values are set as initial values. In the fitting in the step S105b, the parameter group W is fixed to the value calculated in the step S105a, and the parameter group X calculated in the step S105a is set as an initial value. By introducing such pre-fitting processing in advance, highly accurate fitting can be realized in the step S105b.

The pre-fitting in the step S105a uses the expression (11), and the fitting initial values of the spot shift amounts (ξ_{u, 0, 0}, η_{u, 0, 0}) and (ξ_{b, 0, 0}, η_{b, 0, 0}) use the results of the expressions (7) to (10). As described above, the expressions (7) to (10) are based on the assumption that the optical axis of the wavefront W1 coincides with the measurement optical axis 1d. In other words, the spot image to be pre-fitted needs to be acquired in a state where the optical axis of the wavefront W1 coincides with the measurement optical axis 1d. Thus, the aspherical axis 12c needs to coincide with the measurement optical axis 1c. If these axes do not coincide with each other, the wavefronts of the light reflected by the first surface 12a and the second surface 12b significantly incline, and the wavefronts W1 and W2 are also significantly incline. As a result, the shift amounts of the spot groups SP1 and SP2 significantly shift, and stable convergence cannot be expected even when fitting is performed using the shift amount calculated by the expression (11) as an initial value. The step S102 makes the aspherical axis 12c substantially coincide with the measurement optical axis 1c using a contact mechanism or the like, but this mechanism alone cannot provide the installation accuracy necessary for pre-fitting.

Accordingly, in this embodiment, before the spot image is captured in the step S104, the step S103 makes an alignment of the test lens 12 in the x direction, the y direction, the θₓ direction, and the θ_{y} direction. More specifically, similar to the step S104, a spot image is captured first. As described above, the first light L1 and the second light L2 have entered the processor 10, and the light beam diameter of the first light L1 is larger. Thus, the light receiving surface 3a has a donut-shaped area where only the spot group SP1 formed by the first light L1 is formed. Since the spot group SP2 does not exist in this area, the position of the spot group SP1 can be detected according to the conventional simple method. Accordingly, this embodiment detects the position of the spot group SP1 in the donut-shaped area through the processor 10 according to the method described in Japanese Patent Laid-Open No. 2016-38300, and calculates an inclination component and a coma aberration component of the wavefront W1 of the first light L1 detected therefrom. Moreover, following the method described in Japanese Patent Laid-Open No. 2015-75396, etc., this embodiment calculates positional shifts of the aspherical axis 12c in the x direction, the y direction, the θₓ direction, and the θ_{y} direction relative to the measurement optical axis 1c from the inclination component and the coma aberration component of the wavefront W1. In other words, the aspherical axis 12c is calculated from the spot group SP1. Then, the processor 10 issues a command to the stage controller 7a to drive the stage 7 so as to cancel the calculated positional shift amount. This embodiment makes an alignment by referring to the inclination component of the wavefront W1. Since the inclination component of the wavefront W1 is obtained from the shift amount of the spot group SP1, the alignment is made based on the shift amount of the spot group SP1 in the step S103a.

The step S103a makes the alignment of the test lens 12, and the aspherical axis 12c coincides with the measurement optical axis 1c. Thereby, the shift amount of the spot group SP1 to be imaged substantially matches the value calculated by the expressions (7) to (8), and the shift amount of the spot group SP2 approaches to the value calculated by the expressions (9) to (10). As a result, the convergence of pre-fitting in the step S105a is improved.

In the spot S105c, the processor 10 calculates a provisional back surface inclination. Now assume that the aspherical axis 12c coincides with the measurement optical axis 1c, the lenses 4 and 5 are accurately axisymmetric relative to the measurement optical axes 1c and 1d, respectively, and the back surface inclination has a finite value. At this time, since the first surface 12a is not inclined to the measurement optical axis 1c, the inclination (φ_{ξ, b}, φ_{η, b}) of the wavefront W2 incident on the processor 10 is expressed by the following expressions (12) and (13) using the back surface inclination (Δθ_{l, x}, Δθ_{l, Y}), the imaging magnification m of the imaging lens 14, and the refractive index n of the test lens 12.

$$\begin{matrix}{φ}_{ξ , b} = \frac{2 n Δ {θ}_{l , x}}{m} & ( 12 ) \\ {φ}_{η , b} = \frac{2 n Δ {θ}_{l , y}}{m} & ( 13 )\end{matrix}$$

On the other hand, the shift amount (ξ_{b, 0, 0}, η_{b, 0, 0}) of the spot group SP2 has the relationship with the inclination (φ_{ξ, b}, φ_{η, b}) of the wavefront W2 as expressed in the following expressions (14) and (15).

$$\begin{matrix}{ξ}_{b , 0 , 0} = \frac{{q}_{b}}{p} {ξ}_{0 , 0 , 0} - l {φ}_{η , b} & ( 14 ) \\ {η}_{b , 0 , 0} = \frac{{q}_{b}}{p} {η}_{0 , 0 , 0} - l {φ}_{ξ , b} & ( 15 )\end{matrix}$$

From the following expressions (12) to (15), the back surface inclination of the test lens 12 is calculated by the following expressions (16) and (17).

$$\begin{matrix}Δ {θ}_{l , x} = - \frac{m}{2 nl} ( \frac{{q}_{b}}{p} {η}_{0 , 0 , 0} - {η}_{b , 0 , 0} ) & ( 16 ) \\ Δ {θ}_{l , y} = \frac{m}{2 nl} ( \frac{{q}_{b}}{p} {ξ}_{0 , 0 , 0} - {ξ}_{b , 0 , 0} ) & ( 17 )\end{matrix}$$

The step S105c calculates the back surface inclination using the expressions (16) and (17) and the shift amount (ξ_{b, 0, 0}, η_{b, 0, 0}) calculated in the step S105b and the spot interval q_{b}, and sets it to the provisional back surface (Δθ′_{l, x}(θ_{z}=0), Δθ′_{l, y} (θ_{z}=0)).

This embodiment detects the shift amount of the spot group SP2 by coinciding the shift amount of the spot group SP1 with the position specified by the expressions (7) to (10) through the alignment, and calculates the back surface inclination by substituting the result for the expression (16) and (17). This calculation corresponds to calculating the back surface inclination based on the shift amounts of both the spot groups SP1 and SP2 or calculating the back surface inclination based on a shift between the phase of the periodic function formed by the spot group SP1 and the phase of the periodic function formed by the spot group SP2.

The position of the detector 9 may be adjusted so as to satisfy ξ_{0, 0, 0}=η_{0, 0, 0}=0 before the measurement of the inter-surface eccentricity is performed. At this time, from the simplified expressions (16) and (17) (Δθ_{l, x}=mη_{b, 0, 0}/(2nl) and Δθ_{l, y}=−mξ_{b, 0, 0}/(2nl)), the back surface inclination can be calculated without using the spot interval qᵤ and q_{b}. In addition, when an extremely accurate measurement value of the inter-surface eccentricity is unnecessary, the provisional back surface inclination may be calculated from the parameter group X acquired by the pre-fitting in the step S105a without performing the step S105b.

The imaging magnification of the imaging lens 14 is m, which is a designed value, when the first surface 12a is installed on the conjugate surface of the detector 9. However, when the first surface 12a shifts from the conjugate surface, the imaging magnification shifts from m, and an error occurs in the back surface inclination calculated by the expressions (16) and (17). Accordingly, in order to coincide the imaging magnification of the imaging lens 14 with m, the step S103b is provided which makes an alignment of the test lens 12 in the z direction and coincides the first surface 12a with the conjugate plane before the step S104 for capturing the spot image is processed. The step S103b moves the stage 7 in the z direction so as to cancel the positional shift while monitoring the z position shift of the test lens 12 through the length measuring unit 15. At this time, the z position measurement result by the length measuring unit 15 is input into the processor 10, and the stage driving amount is transmitted from the processor 10 to the stage controller 7a based on the result. The length measuring unit 15 is provided with an unillustrated movable mechanism and usually installed away from the optical path, but is inserted between the lens 4 and the test lens 12 in the step S103b. The length measuring unit 15 may use a length measuring unit by a triangulation, a laser length measuring unit, or a white interferometer.

### Measurement Procedure of Inter-Surface Eccentricity: Correction of Systematic Error

The expressions (12) and (13) assume that the lenses 4 and 5 are accurately axisymmetric with respect to the measurement optical axes 1c and 1d, respectively, and the expressions (16) and (17) derived from them are based on the same assumption. However, the lenses 4 and 5 actually have manufacturing errors and installation errors, so they are not strictly axially symmetric. Hence, a systematic error derived from the non-axisymmetric property of the lenses 4 and 5 occurs in the back surface inclination calculated by the expressions (16) and (17). This embodiment extracts and corrects a systematic error derived from the non-axisymmetric property of the lenses 4 and 5 from the measured provisional back surface inclination. As described above, since the test lens 12 can rotate around the optical axis of the test lens 12, this embodiment corrects the systematic error by calculating the eccentricity data when the test lens 12 is located at a first rotating position and a second rotating position.

In the step S106, the processor 10 determines whether the position of the stage 7 in the θ_{z} direction is 180°. When the position of the stage 7 in the θ_{z} direction is 180°, the flow proceeds to the step S108, and when the position of the stage 7 in the θ_{z} direction is not 180°, the flow proceeds to step S107.

In the step S107, the processor 10 rotates the stage 7 by 180° in the θ_{z} direction. Thereafter, the processing of the steps S103a, S103b, S104, and S105 are performed again, and a provisional back surface inclination (Δθ′_{l, x} (θ_{z}=π), Δθ′_{l, y} (θ_{z}=π)) is calculated.

In the step S108, the processor 10 calculates the systematic error (Δθ_{s, x}, Δθ_{s, y}) included in the provisional back surface inclination using the following expressions (18) and (19).

$$\begin{matrix}Δ {θ}_{s , x} = \frac{Δ {θ}_{l , x}^{′} ( 0 ) + Δ {θ}_{l , x}^{′} ( π )}{2} & ( 18 ) \\ Δ {θ}_{s , y} = \frac{Δ {θ}_{l , y}^{′} ( 0 ) + Δ {θ}_{l , y}^{′} ( π )}{2} & ( 19 )\end{matrix}$$

The expressions (18) and (19) are derived from the fact that the provisional back surface inclination is expressed by the following expressions (20) to (23).

Δθ′_{l,x}(0)=Δθ_{l,x}+Δθ_{s,x} (20)

Δθ′_{l,y}(0)=Δθ_{l,y}+Δθ_{s,y} (21)

Δθ′_{l,x}(π)=−Δθ_{l,x}+Δθ_{s,x} (22)

Δθ′_{l,y}(π)=−Δθ_{l,y}+Δθ_{s,y} (23)

In the step S109, the processor 10 calculates the back surface inclination by removing the systematic error (Δθ_{x, x}, Δθ_{x, y}) from the provisional back surface inclination (Δθ′_{l, x}(0), Δθ′_{l, y}(0)). In other words, the systematic error included in the provisional back surface inclination (eccentric data) is corrected. Calculating the systematic error and acquiring the provisional back surface inclination (Δθ′(π)_{l, x}, Δθ′(π)_{l, y}) necessary for the calculation are performed only by the initial measurement after the assembly of the eccentricity measuring apparatus 100, and in the step S109 for the second and subsequent times, the provisional back surface inclination may be corrected with the systematic error acquired for the first time. The back surface inclination may be directly calculated by deleting Δθ_{s, x} and Δθ_{s, y} from the expressions (20) to (23) without performing the step S108.

In the step S110, the processor 10 multiplies the back surface inclination acquired in the step S109 by a designed value R of the curvature radius of the second surface 12b, and converts it into the optical axis shift amounts Δ_{l, x} and Δ_{l, y} of the second surface 12b. Moreover, The processor 10 outputs the optical axis shift amounts Δ_{l, x} and Δ_{l, y} as the eccentric data. In outputting the eccentricity data, it may be displayed on the display unit 10e or may be transmitted to another device via the communicator 10d. Moreover, the back surface inclination acquired in the step S109 may be directly output as eccentricity data. Whether or not the test lens 12 can be shipped may be determined based on the output eccentric data, or the test lens 12 may be further processed to suppress the eccentricity.

### Comparison with Prior Art

As described above, the configuration of the processor 10 is similar to that of a general SHS. SHS is known as a wavefront sensor, and measures a light beam having a gentle single wavefront (equiphase surface). On the other hand, in this embodiment, the measurement target of the processor 10 is a light beam having two wavefronts. FIG. 10 illustrates a simulation result of the phase of the photoelectric field for a light beam having two wavefronts. A steep step is generated on the equiphase surface in addition to simple folding every 2π, and this light beam never has a gentle single wavefront. In other words, in this embodiment, the measurement target of the processor 10 is different from that of the general SHS.

On the other hand, as an optical measurement device configured to measure a light flux not composed of a single wavefront, the eccentricity measurement using an autocollimator is known. This method collects the light reflected on the first surface and the light reflected on the second surface of the test lens, through a common lens, and detects the position of each one spot (totally two spots) formed on the image sensor. Thereafter, the inclination difference (eccentricity) between the first surface and the second surface is obtained from these spot positions. However, this method cannot detect the aspherical axis of the aspheric lens, or cannot measure the back surface inclination based on this result.

The SHS has a huge image sensor and a plurality of microlenses, and can be regarded as “a plurality of autocollimators arranged in parallel.” The SHS can detect an aspherical axis that cannot be detected by a single autocollimator. This embodiment considers this point, and adds a function of analyzing two spot groups to the SHS conventionally known as a (single) wavefront sensor and applies it to the measurement of a light flux that does not form a single wavefront. Thereby, this method can measure the back surface inclination based on the aspherical axis that cannot be measured by the conventional autocollimator.

### Effects

In general, the light receiving surface of the image sensor has pixels divided into about 10 μm. On the other hand, as described above, the processor 10 can be replaced with general SHS, and the general SHS spot diameter is about 40 μm. In other words, the pixel size is an about quarter of the spot size and is not sufficiently small. Under such circumstances, it is not obvious that the shift amount between the two spot groups can be calculated with high accuracy by the fitting in the step S105b.

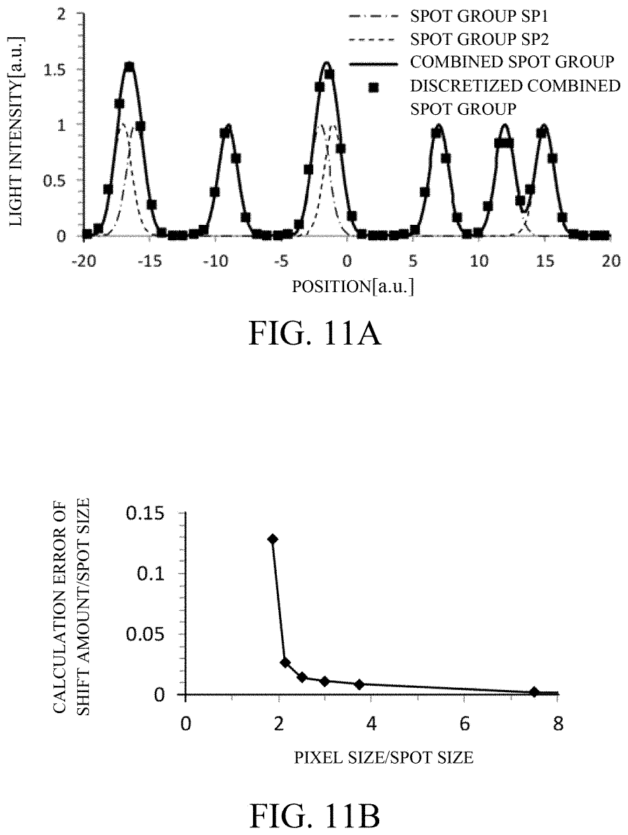

A simulation is performed on the relationship between the pixel size of the image sensor and the calculation error of the shift amount of the spot group. FIGS. 11A and 11B illustrate the simulation results regarding the calculation error of the shift amount of the spot group. FIG. 11A illustrates the simulation result of a spot image having two spot groups. FIG. 11B illustrates the simulation result of the relationship between the pixel size of the image sensor and the shift amount calculation error.

In the simulation, the one-dimensional spot group SP1 and the spot group SP2 are synthesized and discretized with a predetermined pixel size to calculate a spot image. FIG. 11A illustrates a spot image calculated as pixel size/spot size=0.27 in an example. Next, the spot image is fitted with the sum of two periodic functions, and the shift amount calculation error is estimated. By performing this simulation for each pixel size, the relationship between the pixel size and the shift amount calculation error is calculated as illustrated in FIG. 11B. Both the pixel size and the shift amount calculation error are normalized with the spot size and displayed. This result suggests that if the pixel size is less than half of the spot size, the calculation error of the shift amount of the spot group is suppressed to 0.04 times as large as the spot size (=1.6 μm) or less. The calculation error of 1.6 μm is 0.4 minutes when converted into an error of the back surface inclination, which is sufficient as the eccentric accuracy required for a general lens.

Since the accurate shift amount of each spot group can be acquired by fitting, this embodiment can acquire highly accurate inter-surface eccentricity. Since it is unnecessary to scan the measurement probe or the test lens, the inter-surface eccentricity can be quickly acquired.

### Second Embodiment

This embodiment is the same as the first embodiment in using the eccentricity measuring apparatus 100 in FIG. 2 and in measuring the inter-plane eccentricity according to the flowchart in FIG. 6, but is different from the first embodiment in a method for calculating the provisional back surface inclination in the step S105c constituting the step S105.

The first embodiment calculates the provisional back surface inclination using the expressions (16) and (17). The expressions (16) and (17) assume that the aspherical axis 12c completely coincides with the measurement optical axis 1c in consideration of the alignment of the test lens 12 in the step S103a. However, there is a finite error in the wavefront measurement result serving as the reference of the alignment, and there is also the finite installation error in the test lens 12 after the alignment. This embodiment calculates the provisional back surface inclination in consideration of the installation error of the test lens 12.

When the aspherical axis 12c inclines to the measurement optical axis 1c by θ_{x, u} in the θₓ direction and θ_{y, u} in the θ_{y} direction, the inclination of the wavefront W1 of the first light L1 entering the detector 9 (φ_{ξ, u}, φ_{η, u}) is expressed by the following expressions (24) and (25).

$$\begin{matrix}{φ}_{ξ , u} = \frac{2 {θ}_{x , u}}{m} & ( 24 ) \\ {φ}_{η , u} = \frac{2 {θ}_{y , u}}{m} & ( 25 )\end{matrix}$$

When the second surface 12b inclines in the θₓ direction by θ_{x, b}, and θ_{y, b} in the θ_{y} direction, the inclination (φ_{ξ, b}, φ_{η, b}) of the wavefront W2 of the second light L2 entering the detector 9 is expressed by the following expressions (26) and (27).

$$\begin{matrix}{φ}_{ξ , b} = \frac{2}{m} [ n {θ}_{x , b} - ( n - 1 ) {θ}_{x , u} ] & ( 26 ) \\ {φ}_{η , b} = \frac{2}{m} [ n {θ}_{y , b} - ( n - 1 ) {θ}_{y , u} ] & ( 27 )\end{matrix}$$

The back surface inclination (Δθ_{l, x}, Δθ_{l, y}), which is the difference in inclination between the first surface 12a and the second surface 12b, is calculated by the following expressions (28) and (29).

$$\begin{matrix}Δ {θ}_{l , x} = - \frac{m}{2 nl} ( \frac{{q}_{b} - {q}_{u}}{p} {η}_{0 , 0 , 0} + {η}_{u , 0 , 0} - {η}_{b , 0 , 0} ) & ( 28 ) \\ Δ {θ}_{l , y} = \frac{m}{2 nl} ( \frac{{q}_{b} - {q}_{u}}{p} {ξ}_{0 , 0 , 0} + {ξ}_{u , 0 , 0} - {ξ}_{b , 0 , 0} ) & ( 29 )\end{matrix}$$

The step S105c calculates the provisional back surface inclination using the expressions (28) and (29).

This embodiment acquires the inter-surface eccentricity in consideration of the alignment error generated in the step S103a, and can realize a measurement with higher accuracy in comparison with the first embodiment.

### Third Embodiment

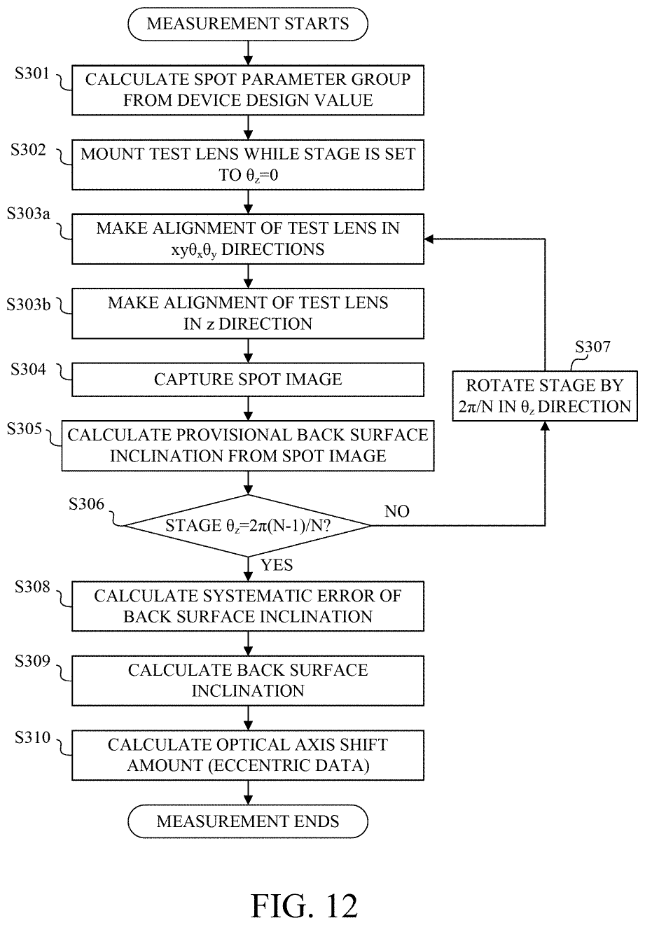

This embodiment is the same as the first embodiment in using the eccentricity measuring apparatus 100 in FIG. 2, but is different from the first embodiment in the measurement procedure of the inter-surface eccentricity of the test lens 12. FIG. 12 is a flowchart illustrating a procedure for measuring the inter-surface eccentricity of the test lens 12 according to this embodiment.

Since the processing of the steps S301 to S305 is the same as the processing of the steps S101 to S105 in FIG. 6, a detailed description thereof will be omitted.

In this embodiment, in comparison with the first embodiment, the number of times of calculating the provisional back surface inclination is changed from 2 times to N times (N≥3).

In the step S306, the processor 10 determines whether or not the position of the stage 7 in the θ_{z} direction is 2π(N−1)/N. When the position of the stage 7 in the θ_{z} direction is 2π(N−1)/N, the flow proceeds to the step S308, and when the position of the stage 7 in the θ_{z} direction is not 2π(N−1)/N, the flow proceeds to the step S307.

In the step S307, the processor 10 rotates the stage 7 by 2π/N in the θ_{z} direction. Thereby, N sets of provisional back surface inclinations (Δθ′_{l, x} (θ_{z}=2πi/N), Δθ′_{l, y} (θ_{z}=2πi/N)) (i=0, 1, . . . , (N−1)) is obtained. In this embodiment, the stage 7 is rotated in the θ_{z} direction by 2π/N each time, but if the rotation angle is known, it is not always necessary to have the same angle every time.

In the step S308, the processor 10 calculates the systematic error of the back surface inclination, but the calculation method is different from that according to the first embodiment. This embodiment fits the obtained provisional back surface inclination value by the following expressions (30) and (31).

Δθ′_{l,x}(θ_{z})=Δθ_{s,x}+Δθₗ cos(θ_{z}−θ_{z,0}) (30)

Δθ′_{l,y}(θ_{z})=Δθ_{s,y}+Δθₗ sin(θ_{z}−θ_{z,0}) (31)

The systematic error (Δθ_{s, x}, Δθ_{x, y}) is calculated by the expressions (30) and (31).

This embodiment calculates the systematic error based on a lot of provisional back surface inclination data in comparison with the first embodiment. Hence, the systematic error can be calculated with higher accuracy and the provisional back surface inclination can be calculated with higher accuracy.

An experiment that measures the back surface inclination of the aspheric lens whose second surface is a flat surface based on this embodiment can show an error of 0.1 minutes or less. This experiment also suggests the effectiveness of this embodiment.

### Fourth Embodiment

This embodiment is the same as the first embodiment in using the eccentricity measuring apparatus 100 in FIG. 2 and in measuring the inter-plane eccentricity according to the flowchart in FIG. 6, but is different in the spot image fitting method in the step S105b constituting the step S105.

The step S105b in the first embodiment assumes that MLs 2a are arranged in a square matrix in the ξ and η directions. However, in reality, there are a manufacturing error of MLA 2 and an installation error in the rotational direction around the optical axis of MLA 2, and MLs 2a are not strictly arranged in the square matrix. Therefore, the step S105b in this embodiment fits the spot image using, for example, the following the expression (32) in consideration of these errors.

$$I ( ξ , η ) = {\sum }_{j , k} {I}_{u} exp \{ - \frac{\begin{matrix}{[ ξ - \frac{{q}_{u}}{p} ( {ξ}_{0 , j , k} - {ξ}_{0 , 0 , 0} ) - {ξ}_{u , 0 , 0} ]}^{2} + \\ {[ η - \frac{{q}_{u}}{p} ( {η}_{0 , j , k} - {η}_{0 , 0 , 0} ) - {η}_{u , 0 , 0} ]}^{2}\end{matrix}}{{w}_{u}^{2}} \} + {\sum }_{j , k} {I}_{b} exp \{ - \frac{\begin{matrix}{[ ξ - \frac{{q}_{b}}{p} ( {ξ}_{0 , j , k} - {ξ}_{0 , 0 , 0} ) - {ξ}_{b , 0 , 0} ]}^{2} + \\ {[ η - \frac{{q}_{b}}{p} ( {η}_{0 , j , k} - {η}_{0 , 0 , 0} ) - {η}_{b , 0 , 0} ]}^{2}\end{matrix}}{{w}_{b}^{2}} \} \qquad ( 32 )$$

As described above, the position (ξ_{0, j, k}, η_{0, j, k}) of each ML 2a has been calibrated, and this calibration value is substituted for the expression (32) in the fitting.

In this embodiment, the spot image is fitted in consideration of the manufacturing error and arrangement error of MLA 2. Thus, the fitting accuracy is more improved than the first embodiment, and a more accurate back surface inclination value can be obtained.

The measurement method according to this embodiment assumes that the MLs are designed to be arranged in the square matrix and intends to cope with the manufacturing error and the arrangement error, but is applicable to randomly arranged MLs.

### Fifth Embodiment

This embodiment is the same as the first embodiment in using the eccentricity measuring apparatus 100 in FIG. 2 and in measuring the inter-plane eccentricity according to the flowchart in FIG. 6, but is different in a calculating method of the provisional back surface inclination in the step S105.

More specifically, the following expression (33) is used instead of the expression (11) when the spot image is pre-fitted in the step S105a constituting the step S105 or the spot image is fitted in the step S105b.

$$I ( ξ , η ) = {\sum }_{j , k} {I}_{u} exp [ - \frac{\begin{matrix}{( ξ - \frac{{q}_{u}}{p} {ξ}_{0 , 0 , 0} + l {φ}_{η , u} - {jq}_{u} )}^{2} + \\ {( η - \frac{{q}_{u}}{p} {η}_{0 , 0 , 0} + l {φ}_{ξ , u} - {kq}_{u} )}^{2}\end{matrix}}{{w}_{u}^{2}} ] + {\sum }_{j , k} {I}_{b} {exp [ - \frac{\begin{matrix}{( ξ - \frac{{q}_{b}}{p} {ξ}_{0 , 0 , 0} + l {φ}_{η , b} - {jq}_{b} )}^{2} + \\ {( η - \frac{{q}_{b}}{p} {η}_{0 , 0 , 0} + l {φ}_{ξ , b} - {kq}_{b} )}^{2}\end{matrix}}{{w}_{b}^{2}} ]}^{2} \qquad ( 33 )$$

Thereby, the inclination (φ_{ξ, u}, φ_{η, u}) of the wavefront W1 of the first light L1 and the inclination (φ_{ξ, b}, φ_{η, b}) of the wavefront W2 of the second light L2 entering the detector 9 are acquired. In the step S105c, the acquired wavefront inclination is substituted for the following expressions (34) and (35) to calculate the provisional back surface inclination.

$$\begin{matrix}Δ {θ}_{l , x} = \frac{m}{2 n} ( {φ}_{η , b} - {φ}_{η , u} ) & ( 34 ) \\ Δ {θ}_{l , y} = \frac{m}{2 n} ( {φ}_{ξ , b} - {φ}_{ξ , u} ) & ( 35 )\end{matrix}$$

The expressions (34) and (35) do not explicitly include the shift amounts of the spot groups SP1 and SP2 when the provisional back surface inclination (eccentric data) is calculated in this embodiment. However, they include the inclination (φ_{ξ, u}, φ_{η, u}) of the wavefront W1 and the inclination (φ_{ξ, b}, φ_{η, b}) of the wavefront W2, and these are in one-to-one correspondence with the shift amounts of the spot groups SP1 and SP2. In other words, this embodiment also corresponds to the calculation of the inter-surface eccentricity based on the shift amounts of the spot groups SP1 and SP2.

### Sixth Embodiment

In the first embodiment, when the first light L1 and the second light L2 enter the processor 10, the wavefronts W1 and W2 can be approximated by spherical waves only near the measurement optical axis 1d. Under this premise, for a model of the expressions (1) to (4) in which the spot groups SP1 and SP2 are both arranged at regular intervals, a spot image at the center is fitted. However, when the aspheric amount of the first surface 12a is large or when it is necessary to improve the accuracy by enlarging the fitting area, it is necessary to treat the wavefronts W1 and W2 as aspherical waves and the model of the first embodiment is not satisfied. This embodiment will describe a method for measuring the eccentricity of the lens 12 with high accuracy even in this case.

When the aspherical amount of the first surface 12a increases, the wavefronts W1 and W2 have axially symmetrical shapes ΔWᵤ(ξ, η) and ΔW_{b}(ξ, η) represented, for example, by the following expressions (36) and (37), respectively, H) is added.

$$\begin{matrix}Δ {W}_{u} ( ξ , η ) = {c}_{u , 9} {Z}_{9} ( \frac{ξ}{{r}_{a}} , \frac{η}{{r}_{a}} ) + {c}_{u , 16} {Z}_{16} ( \frac{ξ}{{r}_{a}} , \frac{η}{{r}_{a}} ) & ( 36 ) \\ Δ {W}_{b} ( ξ , η ) = {c}_{b , 9} {Z}_{9} ( \frac{ξ}{{r}_{a}} , \frac{η}{{r}_{a}} ) + {c}_{b , 16} {Z}_{16} ( \frac{ξ}{{r}_{a}} , \frac{η}{{r}_{a}} ) & ( 37 )\end{matrix}$$

c_{u, i} and c_{b, i} represent Zernike coefficients, and Zᵢ(ξ, η) represents a Zernike function. The Zernike function Zᵢ(ξ, η) is defined by the following expressions (38) and (39).

Z₉(ξ,η)=(1−6ρ²+6ρ⁴) (38)

Z₁₆(ξ,η)=−1+12ρ²−30 ρ⁴+20ρ⁶ (39)

Herein, ρ²=ξ²+η². This embodiment sets the maximum number of terms to 16 when the wavefront is developed by the Zernike function, but may add a higher order axially symmetric component. The spot image at this time is represented by the following expression (40) instead of the expression (11).

$$( 40 )$$

$$I ( ξ , η ) = {\sum }_{j , k} {I}_{u} exp [ - \frac{{{( ξ - {ξ}_{u , 0 , 0} - {jq}_{u} - l \frac{\partial Δ {W}_{u} ( ξ / {r}_{a} , η / {r}_{a} )}{\partial ξ} \vert}_{ξ = {ξ}_{0 , j , k} , η = {η}_{0 , j , k}} )}^{2}}{{w}_{u}^{2}} ] \times exp [ - \frac{{{( η - {η}_{u , 0 , 0} - {kq}_{u} - l \frac{\partial Δ {W}_{u} ( ξ / {r}_{a} , η / {r}_{a} )}{\partial η} \vert}_{ξ = {ξ}_{0 , j , k} , η = {η}_{0 , j , k}} )}^{2}}{{w}_{u}^{2}} ] + {\sum }_{j , k} {I}_{b} exp [ - \frac{{{( ξ - {ξ}_{b , 0 , 0} - {jq}_{b} - l \frac{\partial Δ {W}_{b} ( ξ / {r}_{a} , η / {r}_{a} )}{\partial ξ} \vert}_{ξ = {ξ}_{0 , j , k} , η = {η}_{0 , j , k}} )}^{2}}{{w}_{b}^{2}} ] \times exp [ - \frac{{{( η - {η}_{b , 0 , 0} - {kq}_{b} - l \frac{\partial Δ {W}_{b} ( ξ / {r}_{a} , η / {r}_{a} )}{\partial n} \vert}_{ξ = {ξ}_{0 , j , k} , η = {η}_{0 , j , k}} )}^{2}}{{w}_{b}^{2}} ]$$

In this embodiment, the step S105b uses the Zernike coefficient and the parameter group X as variation parameters to fit the spot image with the calculated value calculated from the expression (40). Other procedures follow the first embodiment.

According to this embodiment, the spot images are modeled with the wavefronts W1 and W2 as aspherical waves and thus can be fitted with high accuracy even when the aspheric amount of the first surface 12a is large. As a result, this embodiment can obtain a highly accurate inter-surface eccentricity as compared with the first embodiment.

### Seventh Embodiment

This embodiment is the same as the first embodiment in using the eccentricity measuring apparatus 100 of FIG. 2 and in measuring the inter-surface eccentricity according to the procedure illustrated in FIG. 6 and is different in calculation procedure.

When a spot image is taken as the sum of periodic functions, it can also be expressed by the following expression (41).

$$I ( ξ , η ) = [ {\sum }_{m} {I}_{u , m} cos ( {mk}_{u} ξ + m {ϕ}_{u , ξ} ) ] [ {\sum }_{n} {I}_{u , n} cos ( {nk}_{u} η + n {ϕ}_{u , η} ) ] + [ {\sum }_{m} {I}_{b , m} cos ( {mk}_{b } ξ + m {ϕ}_{b , ξ} ) ] [ {\sum }_{n} {I}_{b , n} cos ( {nk}_{b} η + n {ϕ}_{b , η} ) ] \qquad ( 41 )$$

Herein, kᵤ and k_{b} are wave numbers of a periodic function and correspond to the spot intervals qᵤ and q_{b}. (ψ_{u, ξ}, ψ_{b, ξ}) and (ψ_{u, η}, ψ_{b, η}) represent phases of the periodic function, and correspond to shift amounts (ξ_{u, 0, 0}, η_{u, 0, 0}), (ξ_{b, 0, 0}, η_{b, 0, 0}) of the spot group. When a two-dimensional complex Fourier transform is performed for this spot image, a Fourier transform image of the following expression (42) is obtained.

I(k_{ξ},k_{η})∝[ΣₘI_{u,m} exp(−imφ_{u,ξ})Δ(k_{ξ}−mkᵤ)][ΣₙI_{u,n} exp(−inφ_{u,η})Δ(k_{η}−nkᵤ)]+[ΣₘI_{b,m} exp(−imφ_{b,ξ})Δ(k_{ξ}−mk_{b})][ΣₙI_{b,n} exp(−inφ_{b,η})Δ(k_{η}−nk_{b})] (42)

A peak is periodically formed in an absolute value map of the complex Fourier transform image. Among them, for the peak of m=n=1, information on the wave number (spot interval) is included at that position, and information on the phase (shift amount of the spot group) is included in an argument at that position. In other words, the information on the parameter group X required to calculate the back surface inclination is included.

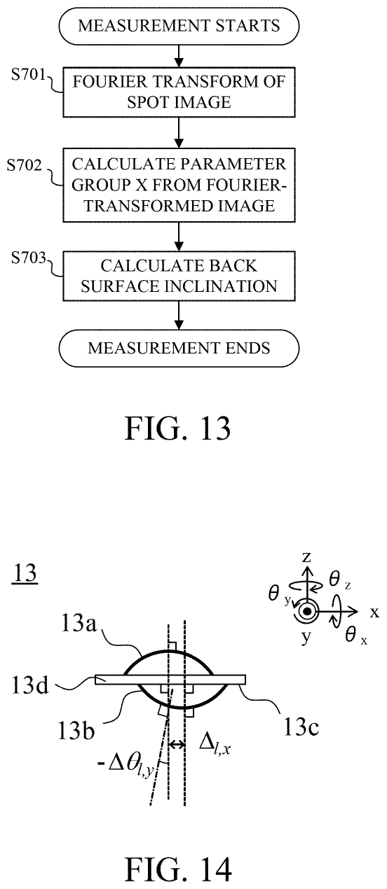

Accordingly, in this embodiment, the step S105 calculates the provisional back surface inclination using a two-dimensional complex Fourier transform. FIG. 13 is a flowchart for explaining a detailed procedure of the processing (step S105 in FIG. 1) for calculating the provisional back surface inclination according to the seventh embodiment.

In the step S701, the processor 10 performs a two-dimensional complex Fourier transform for the spot image.

In the step S702, the processor 10 calculates the parameter group X from the Fourier transform image. In selecting the peak of m=n=1, the spot intervals qᵤ and q_{b} calculated from the device design value in the step S101a may be referred to.

In the step S703, the processor 10 calculates the provisional back surface inclination.

This embodiment requires no fitting work, and can more quickly and more stably calculate the back surface inclination than the first embodiment.

### Eighth Embodiment

The present invention is applicable not only to an aspheric lens but also to a spherical lens. This embodiment will describe a test lens as the aspheric lens and the measurement of the inter-surface eccentricity between the surfaces.

FIG. 14 schematically illustrates a configuration of a test lens 13 according to this embodiment. The test lens 13 has a first surface 13a and a second surface 13b. Both the first surface 13a and the second surface 13b are spherical surfaces. The first surface 13a and the second surface 13b has a round edge 13d. A reference surface 13c is formed on the round edge 13d. The inter-surface eccentricity of the test lens 13 measured in this embodiment is defined as the shift amount (Δ_{l, x}, Δ_{l, y}) of the optical axis of the second surface 13b from the optical axis of the first surface 13a. The optical axis of the first surface 13a is a straight line perpendicular to the reference surface 13c and perpendicular to the second surface 13b. The optical axis of the second surface is a straight line perpendicular to both the second surface 13b and the reference surface 13c. The back surface inclination (Δθ_{l, x}, Δθ_{l, y}) in this embodiment is defined as the inclination of the second surface 13b to the optical axis of the first surface 13a. Similar to the first embodiment, the back surface inclination may be measured as the inter-surface eccentricity.

This embodiment is the same as the first embodiment in using the eccentricity measuring apparatus 100 in FIG. 2 and in measuring the inter-surface eccentricity according to the flowchart in FIG. 6, but is different in the step S102 for mounting the test lens 13 and the step S103a for making an alignment of the test lens 13.

In the step S102, the test lens 13 is installed so that the reference surface 13c is parallel to the xy plane. In this embodiment, the holder 7b has an unillustrated reference surface for receiving the reference surface 13c, and the tilt of the stage 7 is adjusted so that the reference surface is parallel to the xy plane.

In the step S103a for making an alignment of the test lens 13, the stage 7 is adjusted in the x direction and the y direction so as to suppress the tilt component of the wavefront W1 of the first light L1. Unlike the first embodiment, the aspherical axis 12c is not made to coincide with the measurement optical axis 1c, and the wavefront W1 is not adjusted in the θₓ direction and the θ_{y} direction while the wavefront W1 is monitored.

Since there is no step of coinciding the aspherical axis with the measurement optical axis, this embodiment can measure the inter-surface eccentricity between the spherical lens.

### Ninth Embodiment

This embodiment measures the inter-surface eccentricity according to the method described in the first embodiment, and then calculates the shape of the first surface 12a. This processing corresponds to the shape calculating step.

In calculating the shape of the first surface 12a, the stage 7 is set to θ_{z}=0, and the spot image I(ξ, η) and the parameter group X acquired in the steps S104 and S105b, respectively, are substituted for the following expression (43). Thereby, a spot image I′(ξ, η) is calculated in which only the spot group SP1 is extracted and the spot group SP2 caused by the second light L2 is eliminated.

$${I}^{′} ( ξ , η ) = I ( ξ , η ) - {\sum }_{j , k} {I}_{b} exp [ - \frac{{( ξ - {ξ}_{b , 00} - {jq}_{b} )}^{2} + {( η - {η}_{b , 0 , 0} - {kq}_{b} )}^{2}}{{w}_{b}^{2}} ] \qquad ( 43 )$$

Thereafter, the shape of the first surface 12a is calculated from the spot image I′(ξ, η) according to the method described in Japanese Patent Laid-Open No. 2013-186024.

### Tenth Embodiment

This embodiment is the same as the first embodiment in using the eccentricity measuring apparatus 100 illustrated in FIG. 2 to calculate the provisional back surface inclination and perform the eccentricity measurement, but is different in procedure for calculating the provisional back surface inclination. The first embodiment has found the shift amount of each spot group by fitting the spot image with a predetermined function. This embodiment detects the position of each spot constituting the spot image using a temporary spot image that has been separately captured and calculates the shift amount of each spot group.

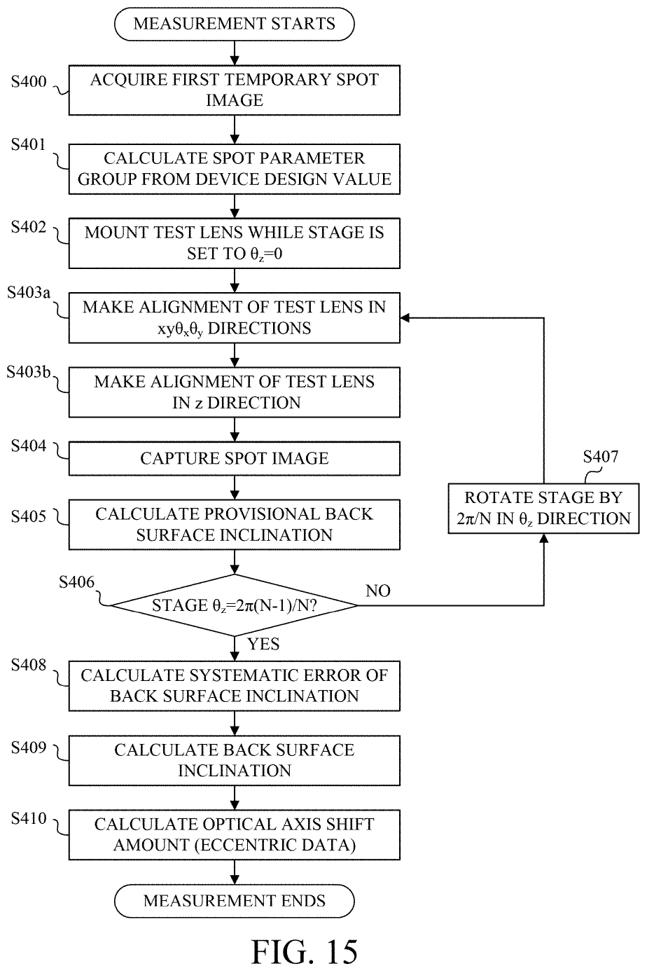

FIG. 15 is a flowchart showing the eccentricity measuring procedure according to this embodiment. The eccentricity measuring procedure will be described with reference to FIG. 15.

In the step S400, the processor 10 acquires a first temporary spot image. Details of the first temporary spot image and its acquisition procedure will be described later.

The steps S401 to S404 are performed, and a spot image is acquired. Since the processing of the steps S401 to S404 is the same as the processing of the steps S101 to S104 in FIG. 6, a detailed description thereof will be omitted.

In the step S405, a provisional back surface inclination is calculated from the spot image and the first temporary spot image. Details will be described later.

The processing of the steps S406 to S410 is executed, and eccentricity data is calculated. Since the processing of the steps S406 to S410 is the same as that of the steps S306 to S310 in FIG. 12, a detailed description thereof will be omitted.

### Description of Step S400 for Acquiring First Temporary Spot Image

An unillustrated spare lens 16 manufactured based on the same designed shape as that of the test lens 12 is used to obtain the first temporary spot image. The spare lens 16 has a third surface and a fourth surface based on the same designed shape as that of each of the first surface 12a and the second surface 12b of the test lens. The fourth surface of the spare lens 16 has received an antireflection treatment. Examples of the antireflection treatment include a formation of an antireflection film and roughening by sandblasting. Alternatively, a gel material may be applied which has a refractive index close to that of the test lens.

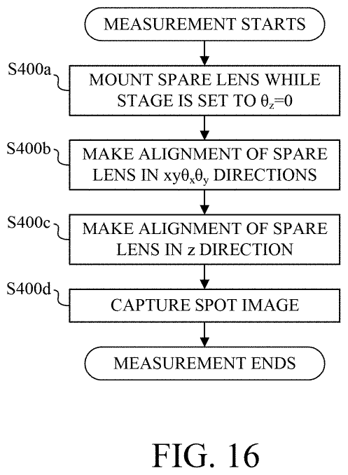

FIG. 16 is a flowchart showing the procedure for acquiring the first temporary spot image according to this embodiment. In the step S400a, the spare lens 16 is installed in the holder 7b. At this time, the third surface is made to face the lens 4 and the fourth surface is brought into contact with the holder 7b. The position of the stage 7 in the θ_{z} direction is set to 0°. In the steps S400b and S400c, the alignment of the spare lens 16 is made in the XYZθₓθ_{y} directions by the same method similar to the steps S103a and S103b in the first embodiment. In the step S400d, the spot group SP3 formed by the light reflected by the third surface of the spare lens 16 is imaged by the image sensor 3, and this is set to the first temporary spot image. Since the designed shape of the third surface of the spare lens 16 is the same as that of the first surface 12a of the test lens 16, the spot group SP3 formed by the light reflected on the third surface (third light) on the spare lens 16 coincides well with the spot group SP1 formed by the first light L1 of the test lens 12.

### Description of Step S405 for Calculating Provisional Back Surface Inclination

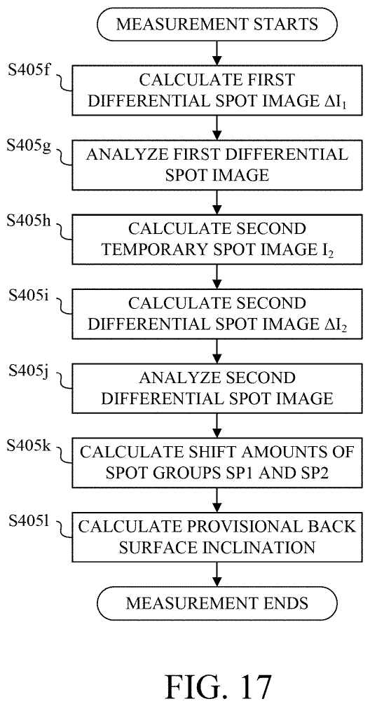

FIG. 17 is a flowchart showing in detail the procedure of the step S405 for calculating the provisional back surface inclination according to this embodiment.

The step S405f subtracts the light intensity distribution (simply referred to as a first temporary spot image hereinafter) constituting a first temporary spot image I_{SP3}(ξ, η) (shown as one temporary spot image) from the light intensity distribution (simply referred to as a spot image hereinafter) I(ξ, η) constituting the spot image acquired in the step S404. The subtraction result is a first differential spot image ΔI₁(ξ, η) (=I−I_{SP3}).

The spot image I(ξ, η) is a sum (I=I_{SP1}+I_{SP2}) of the light intensity distribution I_{SP1}(ξ, η) constituting the spot group SP1 formed by the first light and the intensity distribution I_{SP2}(ξ, η) constituting the spot group SP2 formed by the second light. On the other hand, the first temporary spot image ISP3 is constituted by the spot group SP3 formed by the third light of the spare lens 16, and is similar to the light intensity distribution I_{SP1}. Thus, in the first differential spot image ΔI₁ (=I−I_{SP3}) that is the difference between the spot image I(ξ, η) and the one temporary spot image I_{SP3}, the light intensity distribution I_{SP2} derived from the spot group SP2 remains as it is, and the light intensity distribution I_{SP1} derived from the spot group SP1 is reduced.

Herein, processing for further reducing the light intensity distribution derived from the spot group S_{P1} included in the first differential spot image ΔI₁ may be added. For example, in the first differential spot image ΔI₁, a signal smaller than a predetermined threshold or a negative signal may be converted into zero.

In the step S405g, the first differential spot image ΔI₁ is analyzed, and the position (ξ_{b, j, k}, η_{b, j, k}) of each spot constituting the spot group SP2 is detected. Since the optical signal intensity derived from the spot group SP1 is reduced in the first differential spot image ΔI₁, the position of each spot constituting the spot group SP2 can be detected according to the same method as that in the step S103a in the first embodiment.

In the step S405h, based on the spot position (ξ_{b, j, k}, η_{b, j, k}) detected in the step S405g, the light intensity distribution I₂(ξ, η) (simply referred to as a second temporary spot image hereinafter) constituting the second temporary spot image is calculated. More specifically, for example, the second temporary spot image I₂ is calculated by substituting the spot position (ξ_{b, j, k}, η_{b, j, k}) for the expression (44). Thereby, it is possible to obtain the second temporary spot image I₂ including only the light intensity distribution derived from the spot group SP2 and not including the light intensity distribution derived from the spot group SP1.

$${I}_{2} ( ξ , η ) = {\sum }_{j , k} {I}_{b} exp [ - \frac{{( ξ - {ξ}_{b , j , k} )}^{2} + {( η - {η}_{b , j , k} )}^{2}}{{w}_{b}^{2}} ] \qquad ( 44 )$$

The step S405i subtracts the second temporary spot image I₂ (˜I_{SP2}) from the spot image I(ξ, η) (=I_{SP1}+I_{SP2}) and calculates a second differential spot image ΔI₂(ξ, η) (=I−I₂˜I_{SP1}). In the second differential spot image ΔI₂, the light intensity distribution I_{SP2} derived from the spot group SP2 is reduced, and the light intensity distribution I_{SP1} derived from the spot group SP1 remains as it is. Similar to the step S405f, processing for further reducing the light intensity signal derived from the spot group SP2 may be inserted.

In the step S405j, the second differential spot image ΔI₂ is analyzed, and the position (ξ_{u, j, k}, η_{u, j, k}) of the spot constituting the spot group SP1 is detected. As described above, since the light intensity signal derived from the spot group SP2 is reduced in the second differential spot image ΔI₂, the spot group SP1 is analyzed by analyzing it according to the same method as in the step S103a of the first embodiment, and the position of each spot to be configured can be detected.

The above processing acquires the position (ξ_{u, j, k}, η_{u, j, k}) of each spot constituting the spot group SP1 formed by the first light of the test lens 12, and the position (ξ_{b, j, k}, η_{b, j, k}) of each spot constituting the spot group SP2 formed by the second light. In the step S405k, the shift amounts of the spot groups SP1 and SP2 are calculated using the acquired spot positions. More specifically, for example, the position of each spot (ξ_{u, j, k}, η_{u, j, k}, ξ_{b, j, k}, η_{b, j, k}) and the calibration value of MLA 2 (ξ_{0, j, k}, η_{0, j, k}) and the designed values ρᵤ and ρ_{b} of the curvatures of the wavefronts W1 and W2 are substituted for the expressions (45) to (48), and the shift amounts (ξ_{u, 0, 0}, η_{u, 0, 0}) and (ξ_{b, 0, 0}, η_{b, 0, 0}) are obtained.

$$\begin{matrix}{ξ}_{u , 0 , 0} = \frac{1}{{N}_{spot}} {\sum }_{j , k} [ {ξ}_{u , j , k} - ( 1 + {ρ}_{u} ) {ξ}_{0 , j , k} ] & ( 45 ) \\ {η}_{u , 0 , 0} = \frac{1}{{N}_{spot}} {\sum }_{j , k} [ {η}_{u , j , k} - ( 1 + {ρ}_{u} ) {η}_{0 , j , k} ] & ( 46 ) \\ {ξ}_{b , 0 , 0} = \frac{1}{{N}_{spot}} {\sum }_{j , k} [ {ξ}_{b , j , k} - ( 1 + {ρ}_{b} ) {ξ}_{0 , j , k} ] & ( 47 ) \\ {η}_{b , 0 , 0} = \frac{1}{{N}_{spot}} {\sum }_{j , k} [ {η}_{b , j , k} - ( 1 + {ρ}_{b} ) {η}_{0 , j , k} ] & ( 48 )\end{matrix}$$

Assume that Nₛₚₒₜ is the number of spots used for the calculation. The second term in the symbol Σ in the expressions (45) to (48) shows the spot position where the test lens 12 and the imaging lens 14 are formed as designed and axisymmetric about the measurement optical axes 1c and 1d.

The processing using the expressions (45) to (48) does not necessarily have to be performed for all spots constituting the spot group, but may be performed by extracting a spot group near the measurement optical axis 1d, a specific spot group, or the like.

In the step S405l, the provisional back surface inclination is calculated. The provisional back surface inclination is set to the back surface inclinations Δθ_{l, x}, Δθ_{l, y} calculated by substituting the shift amount (ξ_{u, 0, 0}, η_{u, 0, 0}) of the spot group SP1 obtained in the step S405k and the shift amount (ξ_{b, 0, 0}, η_{b, 0, 0}) of the spot group SP2 for the expressions (28) and (29) in the second embodiment

The above calculation method uses for the spare lens 16 a lens formed based on the same designed shape as the test lens 12, but as long as the third surface and the first surface 12a may have the same designed shape, the shape of the fourth surface, the thickness of the lens, etc. are not questioned. The designed shape is not necessarily the same as that of the third surface. For example, the shape may be similar only in the area to be analyzed, or only the curvature component may be matched.

In calculating the shift amount in the step S405k, the expressions (16) and (17) of the first embodiment may be used. At this time, since the shift amount (ξ_{u, 0, 0}, η_{u, 0, 0}) of the spot group SP1 of the first light is unnecessary, the calculation of the second temporary spot image I₂ is unnecessary. Accordingly, the steps S405h to S405j are omitted.

In addition, before the second temporary spot image I₂ is calculated in the step S405h, the intensity I_{b, j, k} and the spot radius w_{b,j,k} of each spot may be acquired from the first differential spot image ΔI₁. For example, the intensity I_{b, j, k} and the radius w_{b,j,k} of each spot are acquired by cutting the spots one by one from the spot image I(ξ, η) and by fitting them with the expression (49).

$${I}_{j , k} ( ξ , η ) = {I}_{b , j , k} exp [ - \frac{{( ξ - {ξ}_{b , j , k} )}^{2} + {( η - {η}_{b , j , k} )}^{2}}{{w}_{b , j , k}^{2}} ] \qquad ( 49 )$$

### Effects

This embodiment does not need to fit a spot image including a plurality of spots with a predetermined function, and improves the robustness of the analysis in comparison with the first embodiment.

### Explanation of Influence of Detection Error Due to Spot Difference

The first differential spot image ΔI₁ includes a noise ΔI_{SP1} (=I_{SP1}−I_{SP3}) caused by the difference between the spot group SP1 and the spot group SP3. Thus, in the step S405g, in detecting the position of each spot constituting the spot group SP2, a detection error occurs due to this noise ΔI_{SP1}. However, in calculating the shift amount of the spot group, the influence of this detection error is insignificant. This point will be described below.

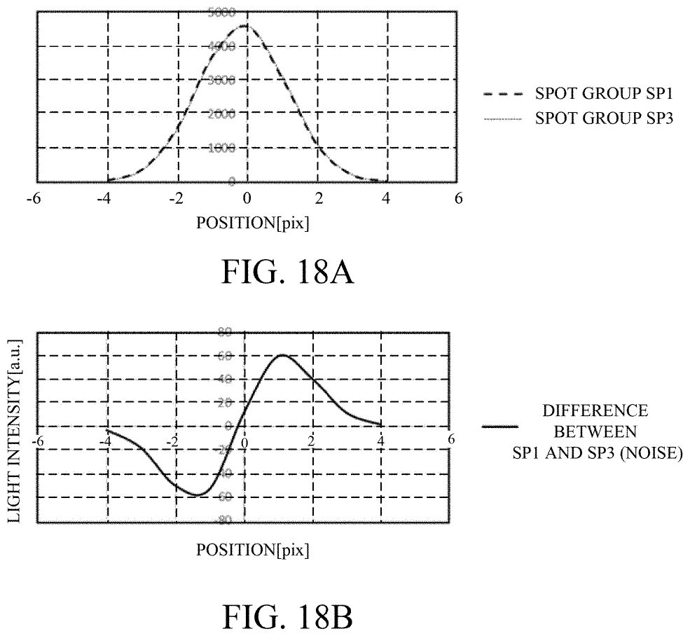

FIGS. 18A and 18B illustrate the simulation result of the noise ΔI_{SP1} included in the first differential spot image ΔI₁. The simulation assumes that the difference between the curvature components of the test lens 12 and the spare lens 16 is 1 μm. FIG. 18A illustrates the light intensity distribution I_{SP1} and the first temporary spot image I_{SP3} constituting the spot groups SP1 and SP3 at this time. For simplified description, the spots constituting each spot group are illustrated one by one. As illustrated in FIG. 18A, the spot groups SP1 and SP3 almost overlap each other, but they are shifted by 0.16 μm due to the difference in the curvature component. FIG. 18B illustrates a result of calculating the noise ΔI_{SP1} by subtracting the light intensity distribution I_{SP1} from the first temporary spot image I_{SP3}. In FIG. 18A, the spot intensity is about 4500, whereas the intensity is about 60 in the noise in FIG. 18B, which is about 1% of the spot intensity. Since the spot groups SP1 and SP2 have approximately the same intensities, the noise intensity ratio relative to the spot group SP2 is also approximately 1%. Therefore, the noise intensity included in the first differential spot image ΔI₁ is about 1% of the spot intensity. For example, if a spot with a diameter of 40 μm overlaps a noise and the light intensity signal changes by 1% between the left and right sides of the spot, a position detecting error of about 100 nm occurs.

The noise ΔI_{SP1} is generated in accordance with the difference between the spot groups SP1 and SP3 and periodically appears similarly to the spot groups SP1 and SP3, and its period is about the same as the period (=spot interval) qᵤ of the spot group SP1. On the other hand, as shown by the expressions (5) and (6), the first surface 12a and the second surface 12b of the test lens 12 have different curvatures from each other, so the period of the spot group SP2 is q_{b}, which is different from qᵤ of the period of the spot group SP1. Thus, the noise appearing in the first differential spot image ΔI₁ shows a period different from that of the spot group SP2. Hence, the positional relationship between each spot constituting the spot group SP2 and the adjacent noise differs for each spot, and the position detecting error caused by the noise in the step S405g shows a different magnitude and direction for each spot.

As shown in the expressions (45) to (48), in calculating the shift amount for the entire spot group, the shift amounts of the Nspot spots are averaged. Hence, the shift amount calculating error for the entire spot group is reduced down to about 1/√Nₛₚₒₜ of the position detecting error of each spot due to the averaging effect. For example, if Nₛₚₒₜ=100, it is reduced down to about 1/10. If the position detecting error of each spot is distributed in the range of −100 to 100 nm, the error of the shift amount of the spot group is about 10 nm. If the distance between the image sensor 3 and the MLA 2 is 5 mm, the calculation error of the surface inclination is assumed to be about 2 μrad, which is sufficiently small compared to the eccentric accuracy required for a general lens.

### Description of Reason for Calculating Second Temporary Spot Image

As described above, the first differential spot image ΔI₁ includes the noise ΔI_{SP1} with the period qᵤ. In calculating the second differential spot image ΔI₂ from the first differential spot image ΔI₁, this embodiment converts the period from qᵤ to q_{b} by introducing the step of calculating the second temporary spot image I₂ through the steps S405g and S405h. Therefore, the noise position is separated from the spot in the second differential spot image ΔI₂ where the spots are arranged at the interval qᵤ. As a result, in detecting the position of the spot included in the second differential spot image ΔI₂ in the step S405j, the detection error is suppressed, and in the subsequent step S405k, the shift amount of the spot group SP1 is accurately calculated.

Assume that the first differential spot image ΔI₁ is directly set to the second temporary spot image I₂ without performing the step S405h. In this case, since the second temporary spot image I₂ includes the noise ΔI_{SP1} (=I_{SP1}−I_{SP3}) in addition to the light intensity distribution I_{SP2} caused by the spot group SP2, I2=I_{SP2}+I_{SP1}−I_{SP3} is established. The step S405i calculates the second differential spot image ΔI₂ as the difference (=I−I₂) between the spot image I (=I_{SP1}+I_{SP2}) and the second temporary spot image I₂ (=I_{SP2}+I_{SP1}−I_{SP3}). As a result, the second differential spot image ΔI₂ coincides with the first temporary spot image I_{SP3}, and the steps S405j and S405k calculate the shift amount of the spot group SP3 instead of the shift amount of the spot group SP1. In other words, the difference between the shift amounts of the spot groups SP1 and SP3 is added as an error to the shift amount of the spot group SP1 calculated in the step S405k.

Hence, this embodiment performs the steps S405g and S405h to calculate the second temporary spot image I₂.

### Eleventh Embodiment

This embodiment is the same as the tenth embodiment in using the eccentricity measuring apparatus 100 illustrated in FIG. 2 and in performing the eccentricity measurement according to the flowchart in FIG. 15, but is different in acquiring method of the temporary spot image.

The step S400 in the tenth embodiment acquires the first temporary spot image I_{SP3} using the spare lens 16, whereas the step S400 according to this embodiment provides the calculation based on the designed value of the test lens 12 and the calibration value of the MLA 2. More specifically, for example, the first temporary spot image I_{SP3} is simulated using the expression (50).

$${I}_{SP 3} ( ξ , η ) = {\sum }_{j , k} {I}_{b} exp [ - \frac{\begin{matrix}{\{ ξ - ( 1 + {ρ}_{b} l ) {ξ}_{0 , 0 , 0} - {jq}_{b} \}}^{2} + \\ {\{ η - ( 1 + {ρ}_{b} l ) {η}_{0 , 0 , 0} - {kq}_{b} \}}^{2}\end{matrix}}{{w}_{b}^{2}} ] \qquad ( 50 )$$

The expression (50) is derived from the expressions (5) to (11) described above, and refers to the designed value of the test lens 12 and the calibration value of MLA 2. As illustrated in the first embodiment, the spot image I may be fitted by the expression (11), and the light intensity distribution calculated by the second term on the right side may be set to the first temporary spot image I_{SP3}. The initial values of the parameter groups X, W, and R required for this fitting are calculated based on the designed value of the test lens 12 and the calibration value of the MLA 2 in the same procedure as the step S101 in the first embodiment.

The steps S400 and S405 according to this embodiment simulate the first temporary spot image I_{SP3} and form the second temporary spot image I₂ based on the result, but may simulate the second temporary spot image I₂ and form the first temporary spot image I_{SP3} based on the result. Further, both the first temporary spot image I_{SP3} and the second temporary spot image I₂ may be obtained by simulation, and the first differential spot image ΔI₁ and the second differential spot image ΔI₂ may be obtained by subtracting each from the spot image I.

Since no spare lens is necessary, this embodiment can reduce the measurement cost as compared with the tenth embodiment.

### Twelfth Embodiment

This embodiment is the same as the tenth embodiment in using the eccentricity measuring apparatus 100 illustrated in FIG. 2 and in performing the eccentricity measurement according to the flowchart in FIG. 15. The step S400 according to the tenth embodiment captures the first temporary spot image I_{SP3}. The step S400 according to this embodiment captures the second temporary spot image I₂. Accordingly, the step S405 calculates the first temporary spot image I_{SP3} and the first differential spot image ΔI₁ based on the second temporary spot image I₂.

The step S400 uses an illustrated spare lens 17. The spare lens 17 has a fifth surface and a sixth surface, and is formed based on the designed shapes of the first surface 12a and the second surface 12b of the test lens 12. An antireflection film is formed on the fifth surface, and most of the light incident on the fifth surface transmits through it. In the step S400, similar to the tenth embodiment, the second temporary spot image I₂ is captured according to the flowchart in FIG. 16. However, when the spare lens 17 is mounted on the holder 7b in the step S400a, the fifth surface is made to face the lens 4 and the sixth surface is brought into contact with the holder 7b.

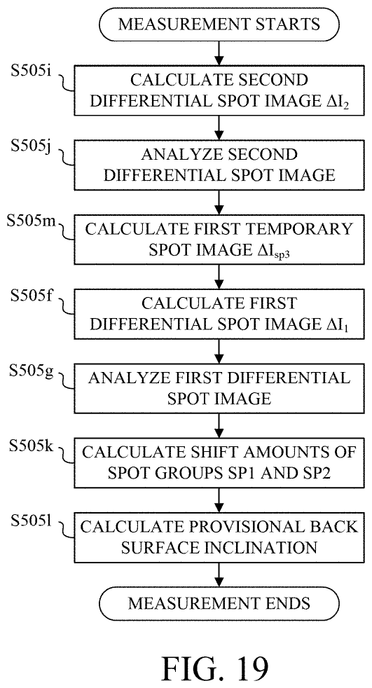

In the step S405 in this embodiment, a provisional back surface inclination is calculated according to a flowchart in FIG. 19. Initially, the steps 505i and 505j are performed to detect the positions (μ_{u, j, k}, η_{u, j, k}) of the spot group SP1. Since the processing of the steps 505i and 505j is the same as that of the steps 405i and 405j in FIG. 17, a description thereof will be omitted. Next, in the step S505m, the spot position (ξ_{u, j, k}, η_{u, j, k}) is substituted for the expression (51) to calculate the first temporary spot image I_{SP3}.

$${I}_{SP 3} ( ξ , η ) = {\sum }_{j , k} {I}_{u} exp [ - \frac{{( ξ - {ξ}_{u , j , k} )}^{2} + {( η - {η}_{u , j , k} )}^{2}}{{w}_{u}^{2}} ] \qquad ( 51 )$$

Thus, the steps S505f, S505g, S505k, and S505l are performed to calculate the provisional back surface inclination. Since the processing in the steps S505f, S505g, S505k, and S505l are the same as that in the steps S405f, S405g, S405k, and S405l in FIG. 17, and a detailed description thereof will be omitted.

Similar to the case of the tenth embodiment, since it is unnecessary to fit a spot image including a plurality of spots, this embodiment improves the robustness of the analysis as compared with the first embodiment.

The step S400 may include both the step of capturing the first temporary spot image I_{SP3} using the spare lens 16 and the step of capturing the second temporary spot image I₂ using the spare lens 17. In this case, in the step S405, the step S505m may be omitted from the flowchart in FIG. 19.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processor (CPU), microprocessor (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-207797, filed on Nov. 2, 2018, which is hereby incorporated by reference herein in its entirety.

What is claimed is:

1. An eccentricity measuring method comprising:
a forming step of dividing reflected light from a first surface and a second surface of a test lens by a plurality of optical elements and of forming a first spot group and a second spot group; and
an eccentricity calculating step of calculating an eccentricity amount of the first surface relative to the second surface based on the first spot group and the second spot group.

2. The eccentricity measuring method according to claim 1, wherein the eccentricity calculating step calculates the eccentricity amount based on a first shift amount of the first spot group and a second shift amount of the second spot group.

3. The eccentricity measuring method according to claim 2, wherein the eccentricity calculating step calculates at least one of the first shift amount and the second shift amount by fitting a spot image with a predetermined function.

4. The eccentricity measuring method according to claim 3, wherein the plurality of optical elements are arranged at regular intervals on the same plane,
wherein the predetermined function is a sum of a periodic function, and
wherein the eccentricity calculating step calculates a phase of the periodic function as at least one of the first shift amount and the second shift amount.

5. The eccentricity measuring method according to claim 3, wherein the predetermined function is a calculated spot image based on a spot group formed when light forming a plurality of wavefronts enters the plurality of optical elements, and
wherein at least one of the plurality of wavefronts is an aspheric wave.

6. The eccentricity measuring method according to claim 2, wherein the eccentricity calculating step calculates at least one of the first shift amount and the second shift amount based on a Fourier transform image of the spot image.

7. The eccentricity measuring method according to claim 2, further comprising a temporary spot image acquiring step of acquiring a temporary spot image based on only one of the first spot group and the second spot group, and
wherein the eccentricity calculating step calculates a difference spot image that is a difference between a light intensity distribution constituting a spot image and a light intensity distribution constituting the temporary spot image, and calculates at least one of the first shift amount and the second shift amount.

8. The eccentricity measuring method according to claim 7, wherein a position of each spot constituting the first spot group or the second spot group is obtained from the difference spot image, and the first shift amount or the second shift amount is calculated.

9. The eccentricity measuring method according to claim 7, wherein the temporary spot image is acquired by imaging light reflected by a spare lens different from the test lens.

10. The eccentricity measuring method according to claim 7, wherein the temporary spot image is calculated and acquired based on a design shape of the test lens.

11. The eccentricity measuring method according to claim 7, wherein the temporary spot image acquiring step includes the steps of acquiring a first temporary spot image that is a temporary spot image based on the first spot group, and acquiring a second temporary spot image that is a temporary spot image based on the second spot group, and
wherein the step of acquiring the second temporary spot image detects a position of a spot included in the differential spot image, which is a difference between a light intensity distribution constituting the spot image and a light intensity distribution constituting the first temporary spot image, and calculates as the second temporary spot image a spot image based on the second spot group.

12. The eccentricity measuring method according to claim 2, wherein the first surface is an axisymmetric aspheric surface, and the eccentricity calculating step calculates the eccentricity based on an aspherical axis calculated from the first spot group and the second shift amount.

13. The eccentricity measuring method according to claim 1, wherein the test lens is rotatable around an optical axis of the test lens, and
wherein the decentration calculating step calculates the eccentricity based on first eccentricity data calculated based on the first spot group and the second spot group when the test lens is located at a first rotation position, and second eccentricity data calculated based on the first spot group and the second spot group when the test lens is located at a second rotational position.

14. The eccentricity measuring method according to claim 1, further comprising a shape calculating step of calculating a shape of the first surface based on the first spot group.

15. The eccentricity measuring method according to claim 14, wherein the shape calculating step calculates the shape of the first surface using a spot image based on the first spot group calculated by removing a spot image based on the second spot group calculated by fitting a spot image with a predetermined function from the spot image.

16. A lens manufacturing method comprising:
a producing step for producing a test lens; and
an eccentricity measuring step for measuring an eccentricity amount of the test lens using an eccentricity measuring method,
wherein the eccentricity measuring method includes:
a forming step of dividing reflected light from a first surface and a second surface of the test lens by a plurality of optical elements and of forming a first spot group and a second spot group; and
an eccentricity calculating step of calculating the eccentricity amount of the first surface relative to the second surface based on the first spot group and the second spot group.

17. An eccentricity measuring apparatus comprising:
a plurality of optical elements configured to divide reflected light from a first surface and a second surface of a test lens and to form a first spot group and a second spot group; and
a calculator configured to calculate an eccentricity amount of the first surface relative to the second surface based on the first spot group and the second spot group.
